(19) United States
(12) Patent Application Publication
(10) Pub. No.: US 2007/0204827 A1
(43) Pub. Date: Sep. 6, 2007

(54) Engine starting device

(75) Inventors: Kazuyoshi Kishibata, Numazu-shi (JP); Mitsuyoshi Shimazaki, Numazu-shi (JP); Tomohiro Kinoshita, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/713,390

(22) Filed: Mar. 2, 2007

(30) Foreign Application Priority Data
Mar. 2, 2006 (JP) 2006-56344

(51) Int. Cl. F02N 17/00; F02M 1/00

(52) U.S. Cl. 123/179.5; 123/179.16

(57) ABSTRACT

An engine starting device which makes fuel injected in preparation for ignition performed in a cylinder of an engine after starting drive of a starter motor in a forward rotational direction so as to start the engine, and makes ignition performed in a suitable ignition position at the time of engine start while the starter motor is driven in a forward rotational direction, the engine starting device being comprised so as to continue driving the starter motor in a direction for starting the engine, even when a crankshaft stops before a piston in a cylinder of the engine reaches a top dead center of a compression stroke.

### TECHNICAL FIELD OF THE INVENTION

The present invention relates to an engine starting device which starts an engine comprising a starter motor.

### BACKGROUND OF THE INVENTION

Usually, when an engine is stopped, a compression load in a compression stroke of the engine serves as a brake, while a crankshaft is rotating through inertia, so that the rotation momentarily stops in the course of a piston in any of cylinders rising toward a top dead center of the compression stroke, and thereafter, the piston is often pushed back and stopped near a bottom dead center. Therefore, when the engine is started, a crankshaft will be rotated with a piston in any of cylinders located near a bottom dead center of a compression stroke.

When the crankshaft is forwardly rotated so as to start the engine from this position, a compression load in a compression stroke is applied to the crankshaft immediately after the rotation is started, and therefore, the rotational speed does not increase easily and the largest load is applied to a starter motor at a crank angle position where the compression load becomes maximum. In the case of a four-cycle engine, a crank angle position where the compression load becomes maximum is a position at about 30° before the top dead center of the compression stroke.

The starter motor needs to generate a torque beyond the maximum load torque applied to the crankshaft when the compression load becomes maximum. In particular, when a rotor of a starter motor is directly connected to a crankshaft, such as the case where a generator whose rotor is directly connected to the crankshaft is used as a starter motor in starting the engine, there is a problem that a large and expensive motor must be used because the motor torque cannot be increased by a reduction gear.

In addition, when a starter motor is used as a generator after the engine is started, using a motor having a large driving torque degrades the engine response because of the large mass of the rotor that causes an excessive inertia. Because the startability and response of an engine are in an antinomical relation, it had not been easy to improve both at the same time.

In order to solve the above described problems, as shown in Japanese Patent Application Laid-Open Publication No. 2002-332938, there is proposed an engine starting device in which a stator motor is once reversely rotated and then forwardly rotated when the engine is started, so that it is possible to go over a compression stroke by using a small starter motor whose output torque is smaller than a maximum load torque applied to a crankshaft in a compression stroke of the engine.

In a starting device shown in Japanese Patent Application Laid-Open Publication No. 2002-332938, when a start command of an engine is given, the starter motor is once reversely rotated to increase an approach length of a piston, and then the starter motor is forwardly rotated, so that the rotational speed of a crankshaft of the engine is increased in the approach region, where a load applied to the starter motor is relatively small to go over the compression stroke by a resultant force of an inertia force stored from the rotational speed and the rotational driving force of the motor.

According to the present inventor's experiment, an engine can be started with the starting device shown in Japanese Patent Application Laid-Open Publication No. 2002-332938, as long as temperature of the starting engine is in a range from normal temperature to about −20° C. However, it has been demonstrated that an engine cannot easily be started by using a starter motor having a torque smaller than a maximum load torque applied to a crankshaft in a compression stroke, under a very low temperature environment where engine temperature becomes lower than −20° C.

Supposedly, the reason why the engine cannot easily be started under the very low temperature environment as described above may be in the fact that a friction torque (a torque applied to a crankshaft from sliding friction of a movable part of the engine) in the engine increases rapidly because of, for example, the increase of the viscosity of engine oil caused by a temperature drop.

That is, because the starter motor needs to work on both of the engine compression load and the friction torque although the engine friction torque increases to an unignorable level of magnitude under the very low temperature environment, it is not possible to use such a starter motor whose output torque is smaller than the maximum load torque (sum of a compression torque and a friction torque) applied to the crankshaft in a compression stroke to start the engine.

### SUMMARY OF THE INVENTION

An object of the present invention is to provide an engine starting device which can start an engine by using a starter motor whose output torque is smaller than a maximum load torque applied to a crankshaft in a compression stroke of the engine, even when an engine friction torque is very large, such as when the engine is started under a very low temperature environment.

The present invention is applied to an engine starting device which starts an engine, comprising at least one cylinder in which a piston is provided, a crankshaft connected to the piston in the cylinder, a fuel injection device which injects fuel in order to generate an air-fuel mixture supplied into the cylinder, an ignition device which ignites the air-fuel mixture compressed in the cylinder, and a starter motor which rotationally drives the crankshaft.

The present invention comprises starter forward rotational drive means for driving the starter motor in a forward rotational direction in order to start the engine, starting time fuel injection control means for causing a fuel injection device to inject fuel for generating an air-fuel mixture supplied into a cylinder of the engine in preparation for ignition performed in the cylinder of the engine after the starter forward rotational drive means starts drive of the starter motor, and starting time ignition control means for causing ignition in a cylinder to be ignited during a crank angle position of the engine being in a section suitable for performing ignition at the time of a start-up in each cylinder of the engine, while the starter forward rotational drive means drives the starter motor in the forward rotational direction.

The above-described starter forward rotational drive means is comprised so as to continue driving the starter motor in the forward rotational direction, which is a direction for starting the engine, until a start of the engine is verified even when the crankshaft stops before the piston in the cylinder of the engine reaches a top dead center of a compression stroke.

When a starter motor whose output torque is smaller than a maximum load torque (a compression torque) applied to a crankshaft in a compression stroke of the engine is used, if engine friction torque is large, the motor win stop when sum of the compression torque and the friction torque exceeds the output torque of the motor while the piston rises toward a top dead center in a compression stroke after a start. However, generally, in a four-cycle engine, because slight compression leakage arises from a piston ring or intake and exhaust valves while the piston rises toward the top dead center of the compression stroke, when the starter forward rotational drive means continues driving the starter motor even after the starter motor stops without the ability to overcome the compression torque and the friction torque, the piston rises slowly with gradual decrease of the compression torque by the compression leakage, and the crankshaft rotates at crawling speed. Because a load applied to the starter motor becomes light when a crank angle position exceeds a compression torque maximum position (this is a position where the compression torque becomes maximum, that is, usually a position near an angle of 30° ahead of a top dead center of a compression stroke) ahead of the top dead center of the compression stroke, the crankshaft increases speed and starts to rotate, the piston goes over the top dead center of the compression stroke easily, and the compression stroke is completed.

Therefore, when an ignition operation is performed at an ignition position suitable for starting the engine, that is, a crank angle position where a rotational driving force generated by an explosion always acts in the forward rotational direction in a state that initial fuel injection has already been performed after a starting operation begins, fuel in the cylinder of the engine combusts and an expansion stroke is performed, and the crankshaft rotates at an accelerated rate by a resultant force of a driving force of the starter motor, and the rotational driving force generated by combustion (explosion) generated in the cylinder. The starter forward rotational drive means makes inertial energy stored at a stretch by this rotation and makes the compression stroke of the following cylinder performed, and subsequently, makes ignition performed in the cylinder to make the expansion stroke performed. Hereafter, the starter forward rotational drive means makes fuel injection and ignition performed repeatedly and makes a combustion cycle performed in each cylinder, and thereby, raises the rotational speed of the crankshaft to complete a start of the engine.

The crank angle position where the rotational driving force generated by an explosion always acts in the forward rotational direction is a crank angle position where the piston in the above described specific cylinder reaches a top dead center of a compression stroke, or a crank angle position which slightly goes over the crank angle position where the piston reaches the top dead center.

In a preferable aspect of the present invention, starter reverse rotational drive means is further provided, the starter reverse rotational drive means which is comprised so that the starter motor can rotationally drive the crankshaft in a forward rotational direction and a reverse rotational direction, and, when a start command of the engine is given, the starter reverse rotational drive means drives the above described starter motor in the reverse rotational direction so as to once reversely rotate the crankshaft. In this case, the starter forward rotational drive means is comprised so as to drive the starter motor in the forward rotational direction so as to forwardly rotate the crankshaft after driving of the starter motor by the starter reverse rotational drive means is completed.

The starter reverse rotational drive means provided in the preferable aspect of the present invention is comprised so as to drive the starter motor in the reverse rotational direction in response to the start command for the engine, and to reversely rotate the crankshaft of the engine until the piston in a specific cylinder, which has been stopped near the bottom dead center of a compression stroke at the time of forward rotation since the engine has stopped, is positioned in a section corresponding to an intake stroke at the time of forward rotation of the engine, or is in a position passed through the section.

In the preferable aspect of the present invention, the above described fuel injection control means is comprised so as to perform initial fuel injection when driving of the starter motor by the starter reverse rotational drive means is completed.

When the starter reverse rotational drive means reversely rotates the starter motor in response to the start command for the engine, the piston in the specific cylinder which has been stopped near the bottom dead center of a compression stroke is returned to a proper crank angle position in the middle of a section corresponding to an intake stroke at the time of forward rotation, or a crank angle position of becoming in a state of the piston passed through the section corresponding to the intake stroke at the time of the forward rotation. Subsequently, when the starter motor is forwardly rotated, an intake stroke is performed in the specific cylinder and an air-fuel mixture is supplied into the specific cylinder, and then, a compression stroke is performed. In the compression stroke, when a crankshaft stops because of the sum of the compression torque and the friction torque exceeding an output torque of the starter motor, it is possible to displace the piston of the engine toward the top dead center of the compression stroke slowly by using gradual decrease of the compression torque because of compression leakage in the cylinder of the engine by continuing driving the starter motor in the forward rotational direction, to accelerate the crankshaft by the starter motor after the compression torque exceeds a maximum value, and to complete the compression stroke. At this time, because the air-fuel mixture including the fuel injected when the reverse rotation of the crankshaft by the starter motor is completed exists in the cylinder in a compressed state, it is possible to make an expansion stroke performed by causing an ignition operation subsequently, and to accelerate the crankshaft at a stretch to start the engine.

As described above, when the crankshaft is caused to reversely rotate once upon the start command, an opportunity of injecting fuel can be provided in preparation for initial ignition after the starter forward rotational drive means starts forward rotation of the starter motor and before an initial compression stroke in the engine is started. Therefore, combustion can be accomplished by the initial ignition after the forward rotation of the crankshaft is started, and this provides an early initial explosion in the engine and improves startability.

It is desirable that an ignition position suitable at the time of a start is a crank angle position where a piston in each cylinder of the engine reaches a top dead center, or a crank angle position which is behind a crank angle position where a piston in each cylinder reaches a top dead center so that a rotational driving force by an explosion may always act in a normal direction.

What are provided in another preferable aspects of the present invention are start reverse rotational drive mode switching means for switching a control mode to a start reverse rotational drive mode in response to the start command for the engine, starter reverse rotational drive means for driving the starter motor in a reverse rotational direction so as to reverse a crankshaft when the control mode is switched to the start reverse rotational drive mode by the start reverse rotational drive mode switching means, reverse rotational drive time determination means for determining whether an elapsed time after starting drive of the starter motor in the reverse rotational direction reaches a set time set at sufficient length of time when the piston in a specific cylinder, which has been stopped near the bottom dead center of the compression stroke at the time of the forward rotation of the engine since the engine had stopped, arrives in a proper position (preferable position near the top dead center of intake stroke at the time of forward rotation) in a section corresponding to the intake stroke at the time of forward rotation of the engine, or a set position set in a position passed through the section, reverse rotating time crank angle position determination means for determining whether the piston in the specific cylinder reaches the above described set position while the starter motor is driven in the reverse rotational direction, start forward rotational drive mode switching means for switching the control mode to a forward rotational drive mode when the reverse rotational drive time determination means determines that the elapsed time reaches the above described set time, or when the reverse rotating time crank angle position determination means determines that the crank angle position arrives in the set position, starter forward rotational drive means for starting drive of the starter motor in the forward rotational direction when the control mode is switched to a forward rotational drive mode, starting time ignition control means for causing ignition in a cylinder to be ignited during a crank angle position of the engine being in a section suitable for performing ignition at the time of start-up in each cylinder of the engine, while the starter forward rotational drive means drives the starter motor in the forward rotational direction, fuel injection control means for causing the specific cylinder of the engine to perform initial fuel injection when the reverse rotational drive time determination means determines that the elapsed time reaches the set time, or when the reverse rotating time crank angle position determination means determines that the crank angle position arrives in the set position, and causing the fuel injection device to perform fuel injection in a crank angle position which is suitable as a position for injecting fuel for generating an air-fuel mixture supplied in a cylinder in which ignition is performed thereafter, start completion determination means for determining whether a start of the engine is completed, starter drive stopping means for stopping drive of the starter motor when the start completion determination means determines that the start of the engine is completed, and normal operation mode switching means for switching the control mode to a normal operation mode when the start completion determination means determines that the start of the engine is completed. Also in this case, the starter forward rotational drive means is comprised so as to continue driving the starter motor in the forward rotational direction even when the crankshaft stops before the piston in the specific cylinder of the engine reaches a top dead center of a compression stroke.

In still another preferable aspect of the present invention, the starting time ignition control means is comprised so as to make multiple ignition performed in a cylinder to be ignited, whenever it is detected that a crank angle position of the engine enters into the section suitable for performing ignition at the time of start-up in each cylinder of the engine.

When the starting time ignition control means is comprised as described above, the starting time ignition control means controlling the ignition device so as to make multiple ignition performed in a cylinder to be ignited, whenever it is detected that the engine crank angle position enters into the section suitable for performing ignition at the time of start-up in each cylinder of the engine while the starter motor rotates the crankshaft, it is possible to increase the opportunity to ignite an air-fuel mixture, therefore even when homogenization of the air-fuel mixture cannot fully be achieved in a cylinder and a portion with deep fuel and a portion with thin fuel exist in the cylinder, it is possible to make combustion in each cylinder securely performed after beginning the starting operation to make a start of the engine securely.

It is preferable that the section suitable for performing ignition at the time of a start in each cylinder of the above described engine is a section in a fixed angular range which is behind the crank angle position corresponding to the top dead center position of a piston of each cylinder.

As the starter motor, it is possible to use a motor which comprises a magnet rotor, a stator having a multiphase armature coil, a Hall sensor for each phase which detects a pole of the magnet rotor in a detection position set to the armature coil for each phase of this stator, and outputs a rectangular wave detection signal, and which is comprised so as to be driven as a brushless motor in starting the engine. In this case, the starting time ignition control means and the fuel injection control means are comprised so as to acquire crank angle information on the engine necessary for control from an output of the Hall sensor for each phase.

As described above, the present invention makes it possible to start an engine by using a small starter motor whose output torque is small and making a compression stroke completed by displacing a piston toward a top dead center of the compression stroke with using gradual decrease of a compression torque following compression leakage in a cylinder of the engine even when an engine piston stops before reaching at the top dead center while a crankshaft is caused to forwardly rotate after once caused to reversely rotate when starting the engine in a state that a maximum load torque applied to the crankshaft of the engine is large.

In an engine, because slight compression leakage arises from a piston ring or intake and exhaust valves, it is possible to achieve the object of the present invention without providing a special mechanism. However, when it takes long time for a piston to go over a top dead center first because there is too little engine compression leakage, it is effective to provide a decompression hole (through hole), which causes the interior of each cylinder of the engine to communicate the outside, in a cylinder head. When such a decompression hole is provided, an air-fuel mixture in a cylinder leaks out through the decompression hole (compression leakage becomes large) while a piston is displaced slowly toward the top dead center of the compression stroke, thereby it is possible to make the piston go over the maximum position of the compression torque in a short time by urging a drop of the compression torque, and it is possible to enhance engine startability by causing the compression stroke, performed first after beginning a start of the engine, to complete in a short time.

As long as an inner diameter of the above described decompression hole is made sufficiently small, remarkable compression leakage occurs only when moving speed of a piston is low, and it is possible to reduce the compression torque effectively. When displacement speed of the piston becomes high after the engine is started, the pressure in the cylinder in a compression stroke increases rapidly in a short time, thereby an amount of the gas which leaks through the decompression hole whose inner diameter is small becomes slight, and the decompression hole becomes in a substantially closed state. Therefore, as long as the inner diameter of the decompression hole is made sufficiently small (for example, a diameter of nearly 1 mm), displacement of the piston toward the top dead center of the compression stroke is made easy with hardly affecting an engine output, and it is possible to enhance startability of the engine.

The above described decompression hole may be provided so that the interior of a cylinder (combustion chamber) may be made to communicate with an exhaust port, or may be made to communicate with a location other than the exhaustion port, for example, the interior of a cam room in which a cam mechanism driving intake and exhaust valves is contained.

When the exhaust port is made to communicate with the decompression hole, a non-combustion gas blows through the decompression hole into the exhaust port, therefore there is a possibility of deteriorating a component of an exhaust gas. On the other hand, when it is made to make the decompression hole communicate with the interior of the cam room, it is possible to prevent the non-combustion gas from being discharged. Since the interior of the cam room (leading to a crank case) in which a blow-by gas (non-combustion gas leaked out from a cylinder) accumulates originally is connected to an inlet system through a blow-by gas reduction passage connected to the crank case, or a blow-by gas reduction passage which is directly connected to the cam room, and the non-combustion gas which leaks from the interior of a cylinder to the interior of the cam room is returned to the inlet system, when the decompression hole is provided so as to communicate with the interior of the cam room, it is possible to return the non-combustion gas, which leaks through the decompression hole, again in the cylinder through the inlet system and to combust it.

Although the decompression hole does not give a large influence on the engine output as long as the inner diameter of the decompression hole is made sufficiently small, when slight leakage of the non-combustion gas is also nonpermissible during an operation of the engine, it is also possible to provide not only a controllable decompression valve which opens and closes the decompression hole, but also valve control means for controlling the decompression valve so as to open the decompression valve in starting the engine, and to close the decompression valve after the start of the engine.

When starting the engine in a state that a friction torque is large, it is preferable to rotate a crankshaft in a reverse direction by reversely rotating the starter motor in response to the start command for the engine as mentioned above, and to make an opportunity of performing initial fuel injection for ignition in a cylinder, in which a compression stroke is performed first after beginning a start. However, when engine compression leakage is relatively large, or when the decompression valve is provided as described above, even if ambient temperature is very low, it is possible to complete a compression stroke relatively easily by continuing driving the starter motor when the crankshaft is in a stopped state or nearly stopped state in the compression stroke performed at the time of the start, and in this case, because it is easy to rotate the crankshaft by one or more rotations until initial ignition after the commencement of the start-up, as illustrated below, even if the starter reverse rotational drive means is omitted to omit a process of once rotating the crankshaft in a reverse direction at the time of beginning a start and performing initial fuel injection, it is possible to make a start of the engine performed without a hitch.

When omitting the starter reverse rotational drive means and making the starter motor forwardly rotated from the beginning upon the start command, it is not possible to make combustion performed even if it is made to try to perform ignition in the cylinder because it is not possible to supply the air-fuel mixture to the cylinder which accepts a compression stroke first in initial rotation of the crankshaft after the start command is given. However, it is possible to supply the air-fuel mixture to a cylinder in which a compression stroke is performed in second rotation of the crankshaft by making initial fuel injection performed in an adequate section (for example, a section where the piston is displaced toward the top dead center in a cylinder in which a compression stroke is first performed in initial rotation of the crankshaft) before a section where a compression stroke of the cylinder is performed, therefore it is possible to make a start of the engine performed without a hitch by causing ignition when the rotational angle position of the crankshaft enters into the section suitable for an ignition operation on the cylinder which accepts the compression stroke in the second rotation of the crankshaft after beginning a start.

As described above, according to the present invention, by providing the starter forward rotational drive means, which continues driving a starter motor in a direction for starting an engine until start of an engine is verified, even when a crankshaft stops before a piston in a cylinder reaches a top dead center of a compression stroke in starting the engine, it is made to make an engine complete a compression stroke by using gradual decrease of a compression torque by engine compression leakage when a crankshaft stops or is in a state just before a stop before the piston in the cylinder reaches the top dead center of the compression stroke because a maximum load torque applied to the crankshaft of the engine is excessive in relation to an output torque of the starter motor, and therefore, even when the load torque applied to the crankshaft of the engine is excessive in relation to the output torque of the starter motor, it is possible to start the engine without a hitch.

Therefore, according to the present invention, it is possible to enhance a startability of the engine without causing increase of cost or causing upsizing of a device by using a starter motor which has excessive performance. In addition, because it is possible to use a small starter motor, it is possible to prevent acceleration performance of an engine from dropping because of excessive inertia of its rotor.

In addition, in the present invention, when it is made to make a crankshaft once reversely rotated before driving a starter in a forward rotational direction by the starter forward rotational drive means in starting the engine, it is possible to make the opportunity to inject fuel for a compression stroke first performed at the time of the start and an expansion stroke performed after that, and therefore, initial explosion can be performed promptly after the starting operation is started to enhance startability of the engine.

In the present invention, when the decompression hole which puts the interior of a cylinder of the engine in communication with the exterior is provided, it is possible to urge a drop of a compression torque by leaking an air-fuel mixture in the cylinder outside while a piston is displaced slowly toward a top dead center of a compression stroke, and therefore it is possible to enhance startability of the engine by making the piston go over a maximum position of the compression torque in a short time when the engine is started in a state that its friction torque is large.

### BRIEF DESCRIPTION OF THE DRAWINGS

The above and other objects and features of the present invention will be apparent from the detailed description of the preferred embodiments of the invention, which is described and illustrated with reference to the accompanying drawings, in which;

FIG. 1 is a structural diagram illustrating construction of hardware of an engine system to which a starting device according to the present invention is applied;

FIG. 2 is a block diagram illustrating electric construction of the system illustrated in FIG. 1;

FIG. 3 is a block diagram illustrating construction of an engine starting device according to the present invention;

FIG. 4 is a sectional view illustrating a principal part of the engine illustrated in FIG. 1;

FIGS. 5A to 5C are explanatory diagrams for describing a relationship between strokes of two cylinders of a parallel two-cylinder four-cycle engine, the change of a load torque following the change of a crank angle, and initial fuel injection performed when reverse drive is completed in the starting device according to the present invention;

FIGS. 6A to 6C are explanatory diagrams for describing the change of strokes of a single-cylinder four-cycle engine, the change of a load torque following the change of a crank angle, and initial fuel injection performed when reverse drive is completed in the starting device according to the present invention;

FIG. 7 is a graph illustrating an example of a relationship between the engine load torque and the crank angle;

FIG. 8 is a graph illustrating an example of a relationship between the output torque and the rotational speed of a starter motor;

FIG. 9 is a graph illustrating an aspect that the rotational speed of a crankshaft changes with the change of a crank angle at the time of starting an engine in an embodiment of the present invention;

FIGS. 10A to 10E are waveform charts illustrating schematically a waveform of an output pulse of a signal generator and waveforms of output signals of Hall sensors which are used in the embodiment of the present invention;

FIG. 11 is a flowchart illustrating algorithm of control mode switching processing which a microprocessor executes in the embodiment of the present invention;

FIG. 12 is a flowchart illustrating algorithm of starting time ignition control processing which the microprocessor executes in the embodiment of the present invention;

FIG. 13 is a time chart for describing an ignition operation in the case of making multiple ignition performed at the time of starting an engine in the embodiment of the present invention;

FIG. 14 is a drawing illustrating a relationship between strokes of two cylinders of a parallel two-cylinder four-cycle engine;

FIG. 15 is a graph illustrating change of a rotational speed at the time of starting the parallel two-cylinder four-cycle engine by using a starter motor, whose output torques are different, in relation to a crank angle;

FIG. 16 is a graph illustrating an example of a relationship between a friction torque and an engine temperature of the two-cycle engine; and

FIG. 17 is a graph illustrating an example of a relationship between an output torque and a rotational speed of the starter motor.

### DETAILED DESCRIPTION OF THE PREFERRED EMBODIMENTS

Before proposing an engine starting device according to the present invention, inventors of the present invention performed a test for searching a reason why it become impossible to start an engine under a very low temperature environment of lower than −20° C. when starting the engine by conventional art by using a small starter motor whose output torque was smaller than a maximum load torque (a compression torque) applied to a crankshaft in a compression stroke of the engine, and so its test result will be described before describing preferred embodiments of the present invention.

In the test which the present inventors performed, a parallel two-cylinder four-cycle engine whose engine displacement is 700 cc was taken for example. In this engine, a phase shift between a first cylinder (abbreviated as #1 in the drawing) and a second cylinder (abbreviated as #2 in the drawing) is 360° in a crank angle, and correspondence between strokes of the first cylinder and the second cylinder is as illustrated in FIG. 14. In this drawing, “air intake”, “compression”, “expansion”, and “exhaustion” illustrate an intake stroke, a compression stroke, an expansion stroke, and an exhaust stroke, respectively. In addition, #1 means a first cylinder and #2 means a second cylinder.

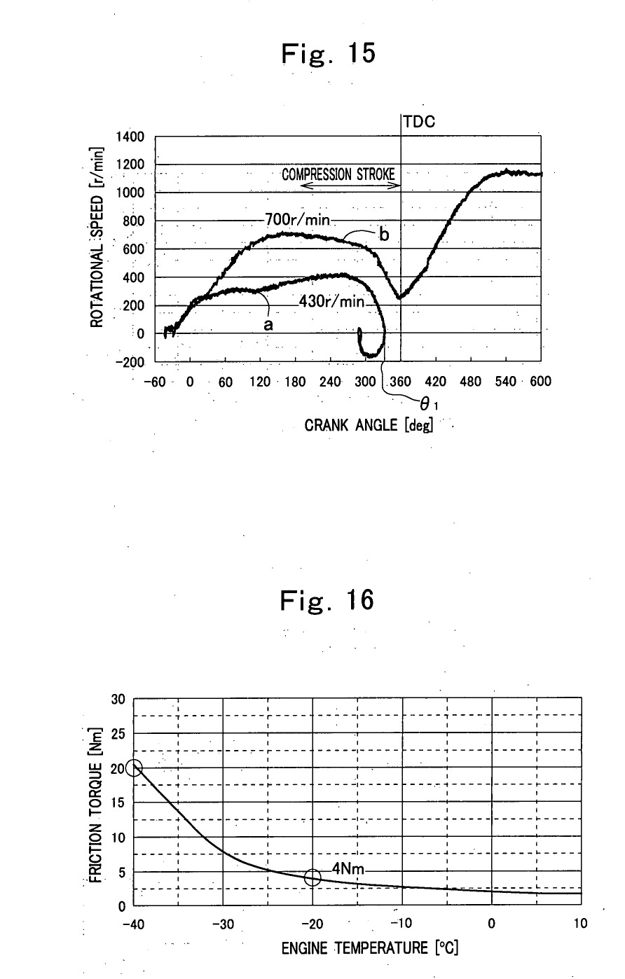

In an embodiment illustrated in Japanese Patent Application Laid-Open Publication No. 2002-332938, it is described that rotational speed of a crankshaft just before an engine rushes into a compression stroke needs to be 700 to 900 r/min so as to store inertia energy necessary for a piston to go over a top dead center of the compression stroke at the time of a start. Similarly, also in the engine examined this time, the rotational speed of the crankshaft just before the piston rushed into a compression stroke needed to be approximately 700 r/min. FIG. 15 illustrates a relationship between the rotational speed and the crank angle in starting the engine which are measured in this test. In this drawing, the vertical axis denotes the rotational speed, and the horizontal axis denotes the crank angle.

In FIG. 15, in the crank angle of the horizontal axis, a top dead center (TDC) of the piston in a compression stroke of the first cylinder is 360° . A curve a in FIG. 15 expresses a case where the rotational speed of the crankshaft just before the piston rushes into a compression stroke is 430 r/min, and a curve b expresses a case where this rotational speed is 700 r/min. Apparently from FIG. 15, in this example, when the rotational speed just before rushing into the compression stroke is 700 r/min, the piston can go over the top dead center of the compression stroke, but, when it is 430 r/min, inertial energy is insufficient, and therefore, the piston is rebounded in a crank angle position θ1 corresponding to approximately 330° in the middle of the compression stroke.

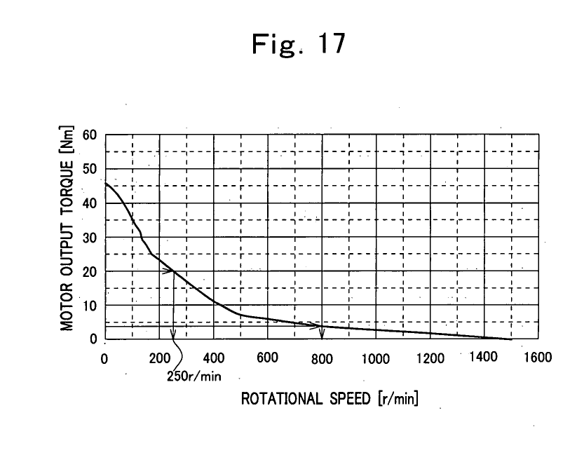

In addition, FIG. 16 illustrates a relationship between a friction torque and a starting engine temperature of the engine. The engine friction torque [Nm] shows a relatively small value in a range from normal temperature to −20° C., but, when the engine temperature becomes lower than −20° C., it becomes large rapidly due to increase of viscosity of engine oil and the like. The starter motor must work not only for the engine compression load, but also for this friction torque.

FIG. 17 illustrates output torque-rotational speed characteristics of the starter motor mounted in the engine used for the test. In the case where the starter motor illustrated in FIG. 17 is used, when temperature at the time of start-up of an engine is −20° C. and a friction torque is 4 [Nm], it is possible to accelerate the crankshaft up to approximately 800 r/min by performing cranking by this motor. It is possible to fully accumulate inertial energy when it is possible to accelerate the crankshaft up to 800 r/min at the time of start-up, and therefore it is possible to make the compression stroke completed without a hitch and to start the engine.

On the other hand, in the case where an engine temperature at the time of start-up is −40° C. and a friction torque of the engine is 20 [Nm], when the starter motor in FIG. 17 performed cranking, it is possible to accelerate the crankshaft only up to 250 r/min. In this case, even if the crankshaft was made once reversely rotated at the time of start-up and long approach length was kept, inertia energy was not fully accumulated, and therefore, it was not possible to make the compression stroke completed and to start the engine.

In addition, what are proposed in the engine starting device disclosed in Japanese Patent Application Laid-Open Publication No. 2002-332938 are to provide a decompression mechanism with structure of lifting up an exhaustion valve forcibly by magnetizing a solenoid, to perform cranking in a state that this decompression mechanism opens the exhaustion valve (in a state that a compression torque is reduced), to close the exhaustion valve when rotational speed of the crankshaft increases to a predetermined rotational speed in an approach region, and to make a compression stroke performed.

However, because the decompression mechanism which opens an exhaustion valve forcibly has complicated structure, when this decompression mechanism is provided, it causes increasing of engine cost, which is not preferable. In addition, when engine temperature is extremely low and an engine friction torque is extremely large, even if cranking is performed in a state that a compression torque is not applied by the decompression mechanism, it is not possible to fully accelerate the crankshaft, and the piston is rebounded when the solenoid of the decompression mechanism is made to be non-magnetized to close the exhaustion valve, and therefore, it is not possible to make the compression stroke completed.

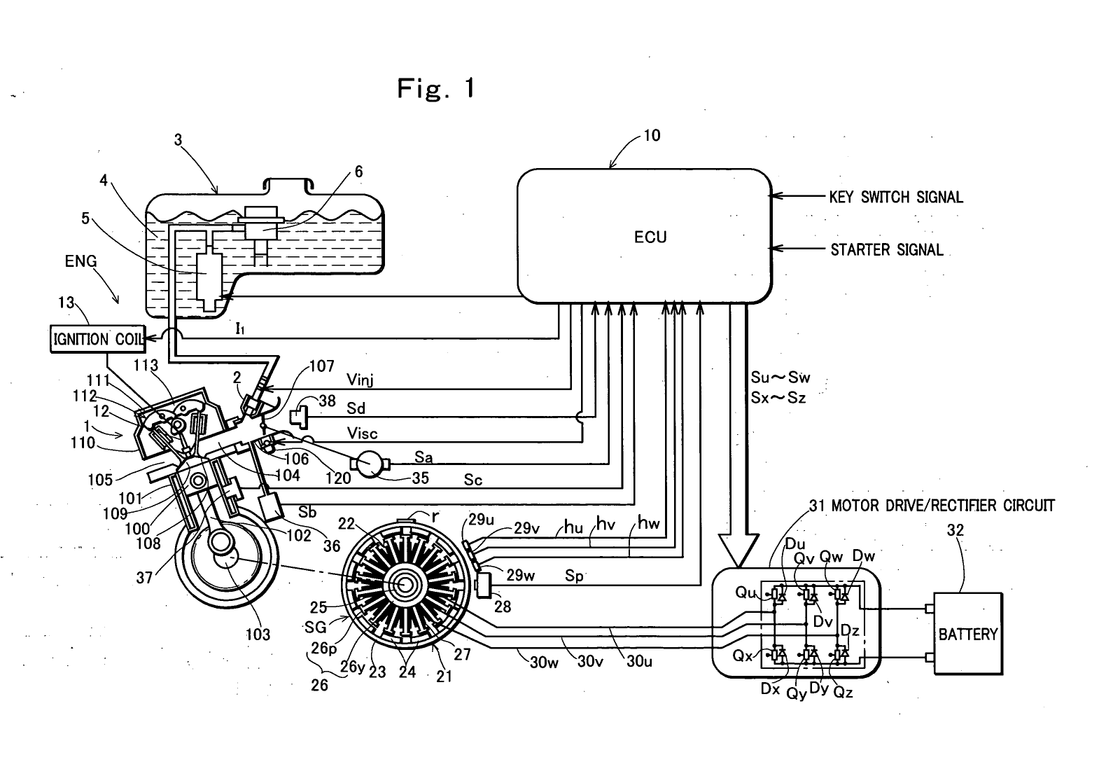

The present invention solves the above described problems which the conventional art had, and enhances startability of an engine at the time of very low temperature. Hereafter, preferred embodiments of the present invention will be described by using FIGS. 1 to 13.

FIG. 1 illustrates construction of an engine system to which an engine starting device according to the present invention is applied. In this drawing, ENG denotes a parallel two-cylinder four-cycle engine. A phase difference between the combustion cycle of a first cylinder and the combustion cycle of a second cylinder of this engine is 360°. A reference numeral 1 denotes an engine body, and the engine body 1 has two cylinders 101 (only the first cylinder is illustrated in the drawing) in each of which interior a piston 100 is provided, and a crankshaft 103 connected to the piston 100 in a cylinder through a connecting rod 102.

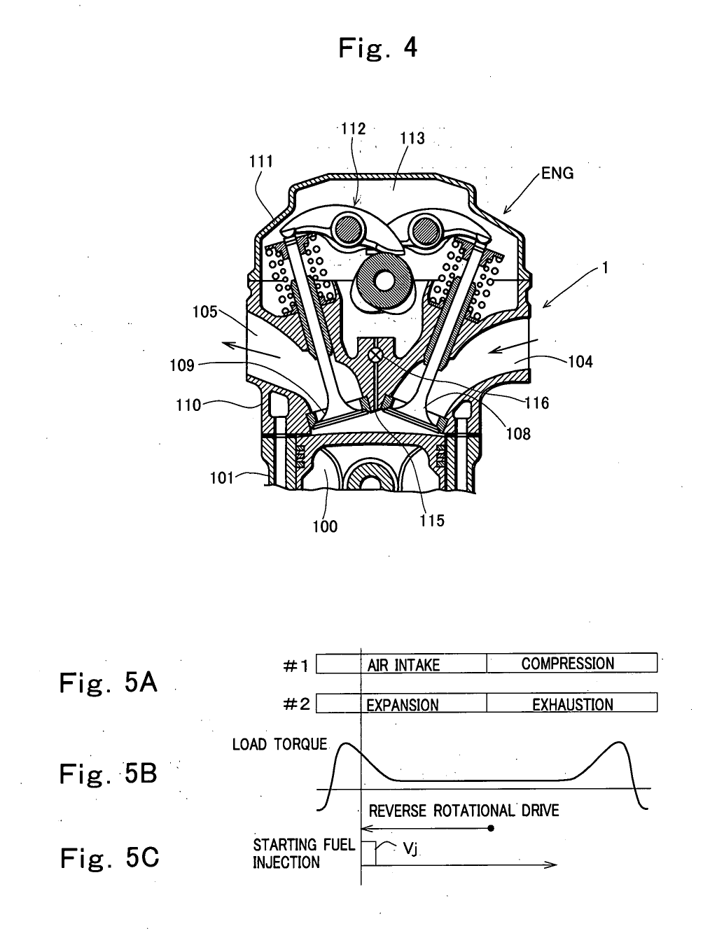

As illustrated in FIG. 4, the engine body 1 has an inlet port 104 and an exhaust port 105, and an intake pipe 106 is connected to the inlet port 104. A throttle valve 107 is provided in the intake pipe 106. An intake valve 108 and an exhaustion valve 109 are provided so as to open and close the inlet port 104 and the exhaust port 105 respectively. A cam cover 111 is mounted in an upper portion of a cylinder head 110 of the engine body, and a cam chamber 113 which contained a cam mechanism 112 which drives the intake valve 108 and the exhaustion valve 109 is provided inside the cam cover 111.

In this embodiment, a decompression hole 115 (refer to FIG. 4) is provided so as to make the interior of each cylinder 101 and the interior of the cam chamber 113 communicate mutually. In addition, in order to open and close the decompression hole 115, a decompression valve 116 which is comprised of a controllable solenoid valve is provided, and decompression valve control means is provided, the decompression valve control means controlling the decompression valve so as to open the decompression valve 116 in starting the engine, and to close the decompression valve 116 after the start of the engine.

Although it is also possible to apply the starting device according to the present invention to a case where one intake pipe is provided commonly to a plurality of cylinders, in this embodiment, the intake pipe 104 is provided for every cylinder of the engine.

In addition, the engine ENG comprises a fuel injection device which injects fuel in order to generate an air-fuel mixture supplied into each cylinder 101 through the intake pipe 106, an ignition device which ignites the air-fuel mixture compressed in each cylinder 101, and a starter motor which can rotationally drive the crankshaft 103 in a forward rotational direction and a reverse rotational direction.

In an illustrated example, an injector (electromagnetic fuel injection valve) 2 is mounted so as to inject fuel into the intake pipe or the inlet port downstream from the throttle valve 107. The injector 2 is widely known one which has an injector body which has a nozzle at its end, a needle valve which opens and closes the nozzle, and a solenoid which drives the needle valve. In the injector body, fuel is supplied from a fuel feed pump 5 which pumps out fuel 4 in a fuel tank 3. Pressure of the fuel supplied to the injector 2 from the fuel feed pump 5 is kept constant by a pressure regulator 6. The solenoid of the injector 2 is connected to an injector drive circuit provided in an electronic control unit (ECU) 10. The injector drive circuit gives a drive voltage to the solenoid of the injector 2, when an injection command signal is generated in the ECU. While a drive voltage Vinj is given to the solenoid from the injector drive circuit, the injector 2 opens the valve and injects the fuel in the intake pipe. When the pressure of the fuel given to the injector is kept constant, an injection amount of fuel is controlled with an injection time (a time while the valve of the injector is opened).

In this example, the fuel injection device is comprised of the injector 2, the injector drive circuit which is not illustrated, and fuel injection control means for giving an injection command to the injector drive circuit.

As illustrated in FIG. 1, an ignition plug 12 for each cylinder is mounted to the cylinder head of the engine body. Each ignition plug has a discharge gap at the end thereof and the discharge gap is disposed in a combustion chamber of each cylinder 101. The ignition plug for each cylinder is connected to a secondary side of an ignition coil 13 for each cylinder. A primary side of the ignition coil 13 for each cylinder is connected to an ignition circuit which is provided in the ECU 10. The ignition circuit (not illustrated) is a circuit which makes a primary current I1 of the ignition coil 13 rapidly changed when an ignition command is given from an ignition command generating section, and makes a high voltage for ignition induced in the secondary coil of the ignition coil 13. The ignition device which ignites the engine is comprised of the ignition plug 12, the ignition coil 13, the ignition circuit which is not illustrated, and the ignition command generating section which gives an ignition command to the ignition circuit. The ignition command generating section is comprised of steady-state ignition control means for arithmetically operating an ignition position at the time of an engine normal operation and generating an ignition command when the ignition position arithmetically operated is detected, and starting time ignition control means for generating an ignition command in the ignition position, which is suitable for a start of the engine, at the time of starting the engine.

In the engine illustrated in FIG. 1, an ISC (Idle Speed Control) valve 120 operated by a solenoid so that the throttle valve may be bypassed is provided. In the ECU 10, an ISC valve drive circuit which gives a drive signal Visc to the ISC valve 120 is provided. The ISC valve drive circuit gives the drive signal Visc to the ISC valve 120 so as to keep the rotational speed of engine idling constant.

In this embodiment, an electric rotating machine (called a starter generator) SG which is driven as a brushless motor at the time of start-up of an engine and is operated as a generator after the start of the engine is mounted in the engine, and this electric rotating machine SG is used as the starter motor. The electric rotating machine SG is comprised of a rotor 21 mounted in the crankshaft 103 of the engine, and a stator 22 fixed to a case of the engine body, or the like.

The rotor 21 is comprised of an iron rotor yoke 23 formed in a cup shape, and permanent magnets 24 mounted in an inner periphery of the rotor yoke 23. In this example, twelve poles of magnet field are comprised of the permanent magnets 24 mounted in the inner periphery of the rotor yoke 23. The rotor 21 is mounted in the crankshaft 103 by fitting a taper section at an end of the crankshaft 103 of the engine in a tapered hole formed inside a boss portion 25 which is provided in a center of a bottom wall section of the rotor yoke 23 to fasten the boss portion 25 to the crankshaft 103 by a threaded member.

The stator 22 is comprised of a stator core 26 in which 18 salient pole sections 26p are radially protruding from an outer periphery of an annular yoke 26y, and an armature coil 27 which is wound around a series of salient pole sections 26p of the stator core and is three-phase connected, and a pole section at an end of each salient pole section 26p of the stator core 26 is faced to a pole section of the rotor through a predetermined air-gap.

A reluctor r which is comprised of an arc-shaped protrusion is formed on an outer periphery of the rotor yoke 23, and a signal generator 28 is mounted in an engine case side. The signal generator 28 detects a leading edge and a trailing edge of the reluctor r in a rotational direction respectively and generates pulses whose polarities are different.

In a stator side of the electric rotating machine SG, there are provided Hall sensors 29u to 29w, such as a hall IC. The Hall sensors 29u to 29 are arranged in a detection position set to an armature coil of each of three phases and detect magnetic polarity of each pole of the magnet field of the rotor 21. In FIG. 1, although it is illustrated that the three-phase Hall sensors 29u to 29w are arranged outside the rotor 21, actually, the three-phase Hall sensors 29u to 29w are arranged inside the rotor 21, and are mounted on a printed circuit board fixed to the stator 22. A mounting method of the Hall sensors is the same as that in a usual three-phase brushless motor. The Hall sensors 29u to 29w output position detection signals hu to hw which are voltage signals of square waveform whose levels are different in the case of a detected pole being an N pole, and in the case of being an S pole.

The three-phase armature coils of the electric rotating machine SG are connected to AC terminals of a motor drive/rectifier circuit 31 through wirings 30u to 30w, and a battery 32 is connected between DC terminals of the motor drive/rectifier circuit 31. The motor drive/rectifier circuit 31 is a well known circuit comprising an H bridge type three-phase inverter circuit (motor drive circuit) whose three-phase branches are comprised of switch elements Qu to Qw, and Qx to Qz, which are on-off controllable, such as MOSFETs or power transistors, and a diode bridge three-phase full wave rectifier circuit which is comprised of diodes Du to Dw and Dx to Dz which are anti-parallel connected to the switch elements Qu to Qw and Qx to Qz of the inverter circuit, respectively.

In order to make the electric rotating machine SG operate as a brushless motor (starter motor), a drive current commutated in a predetermined phase sequence is supplied to the three-phase armature coil 27 through the inverter circuit from the battery 32 by the switch elements of the inverter circuit being on-off controlled according to a rotational angle position of the rotor 21 which is detected from outputs of the Hall sensors 29u to 29w.

After the engine is started, the electric rotating machine SG is driven by the engine and operated as a generator to generate a three-phase AC output. The output obtained from the armature coil 27 is supplied to the battery 32 and various kinds of loads (not illustrated) connected to the ends of the battery 32 through the full wave rectifier circuit in the motor drive/rectifier circuit 31. A voltage across the battery 32 is controlled so as not to exceed a set value by controlling the switch elements comprising upper branches of the bridge of the inverter circuit or the switch elements comprising lower branches of the bridge to turn on-off at the same time according to the voltage across the battery 32.

For example, when the voltage across the battery 32 is below the set value, the switch elements Qu to Qw and Qx to Qz which comprise the H bridge of the inverter circuit are held at an OFF state, and therefore, an output of the rectifier circuit in the motor drive/rectifier circuit 31 is applied to the battery 32 as it is. When the voltage across the battery 32 exceeds the set value, three switch elements Qx to Qz (or Qu to Qw) which comprise three lower branches (or upper branches) of the bridge of the inverter circuit respectively are turned into an ON state at the same time, and therefore, the three-phase AC output of the generator is short-circuited to reduce the voltage across the battery 32 below the set value or lower, the voltage across the battery 32 is kept at a value near the set value by repetition of these operations.

Instead of performing the control described above, it is also possible to control an generation output of the electric rotating machine in order to keep a voltage across the battery 32 within a set range, by providing inverter control means for controlling an inverter circuit so as to apply an AC control voltage to the armature coil of the electric rotating machine SG from the battery 32.

The AC control voltage has a frequency equal to that of an induced voltage of the armature coil, and has a phase angle in relation to the induced voltage of the armature coil at the time of no load. The generation output of the electric rotating machine is increased or decreased by changing the phase angle of the AC control voltage according to a change of the voltage across the battery 32 to keep a voltage across the battery within a set range.

When MOSFETs are used as the switch elements which comprise respective branches of the bridge of the inverter circuit, it is possible to use parasitic diodes formed between drains and sources of the respective MOSFETs as the above described diodes Du to Dw and Dx to Dz.

In addition, in the illustrated example, what are provided so as to give engine information to a microprocessor of the ECU 10 are a throttle position sensor 35 which detects a position (opening degree) of the throttle valve 107, a pressure sensor 36 which detects intake pipe pressure downstream from the throttle valve 107, a cooling water temperature sensor 37 which detects engine cooling water temperature, and an intake air temperature sensor 38 which detects temperature of air sucked into the engine.

As described above, in this embodiment, although the rotor of the electric rotating machine (starter generator) SG is directly connected to the crankshaft of the engine, and this electric rotating machine is used as a starter motor in starting the engine and used as a generator after the engine is started, control at the time of operating the electric rotating machine SG as a starter motor is described in description below about the engine starting device, and this electric rotating machine SG will be called a starter motor for convenience.

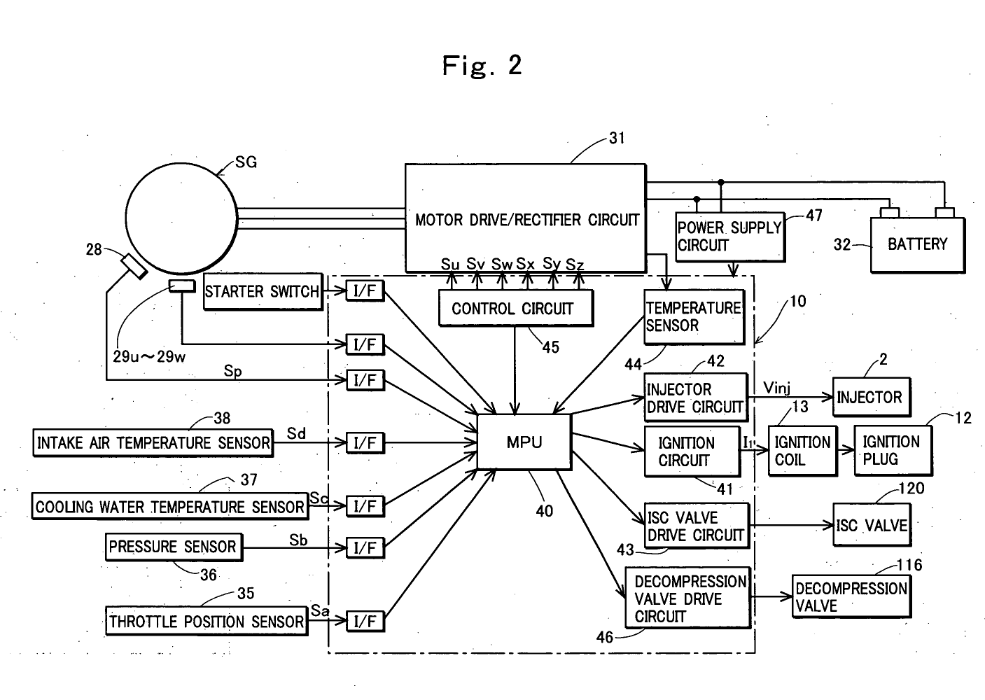

With reference to FIG. 2, electric construction of the system illustrated in FIG. 1 is illustrated in a block diagram. The ECU 10 comprises a microprocessor (MPU) 40, an ignition circuit 41, an injector drive circuit 42, an ISC valve drive circuit 43, a temperature sensor 44 which detects temperature of the motor drive/rectifier circuit 31, a control circuit 45 which gives a drive signal to the switch elements of the inverter circuit of the motor drive/rectifier circuit 31 according to a command given from the microprocessor 40, a decompression valve drive circuit 46 which gives a drive current to the decompression valve 116, and a predetermined number of interface circuits I/F.

The microprocessor 40 comprises various kinds of control means necessary for controlling an engine by executing predetermined programs, stored in ROM. In the illustrated example, in order to give engine information to the microprocessor, a throttle position signal Sa obtained from the throttle position sensor 35, an intake pipe pressure detection signal Sb obtained from the pressure sensor 36, a cooling water temperature detection signal Sc obtained from the cooling water temperature sensor 37, and an intake air temperature detection signal Sd obtained from the intake air temperature sensor 38 are input into the microprocessor in ECU 10 through the interface circuits I/F. In addition, the output signals hu to hw of the hall sensors 29u to 29w and an output Sp of the signal generator 28 are input into the microprocessor 40 through the designated interface circuits I/F.

The primary current I1 is supplied to the ignition coil 13 from the ignition circuit 41 in the ECU 10, and the drive voltage Vinj is given to the injector 2 from the injector drive circuit 42 in the ECU 10. In addition, the drive signals (signals for making the switch elements into the ON state) Su to Sw, and Sx to Sz are given to the six switch elements Qu to Qw and Qx to Qz of the inverter circuit of the motor drive/rectifier circuit 31 from the control circuit 45, respectively.

In FIG. 2, a reference numeral 47 denotes a power supply circuit where an output voltage of the battery 32 is input, and the power supply circuit 47 outputs a supply voltage supplied to each section of the ECU 10 by stepping down and stabilizing the output voltage of the battery 32.

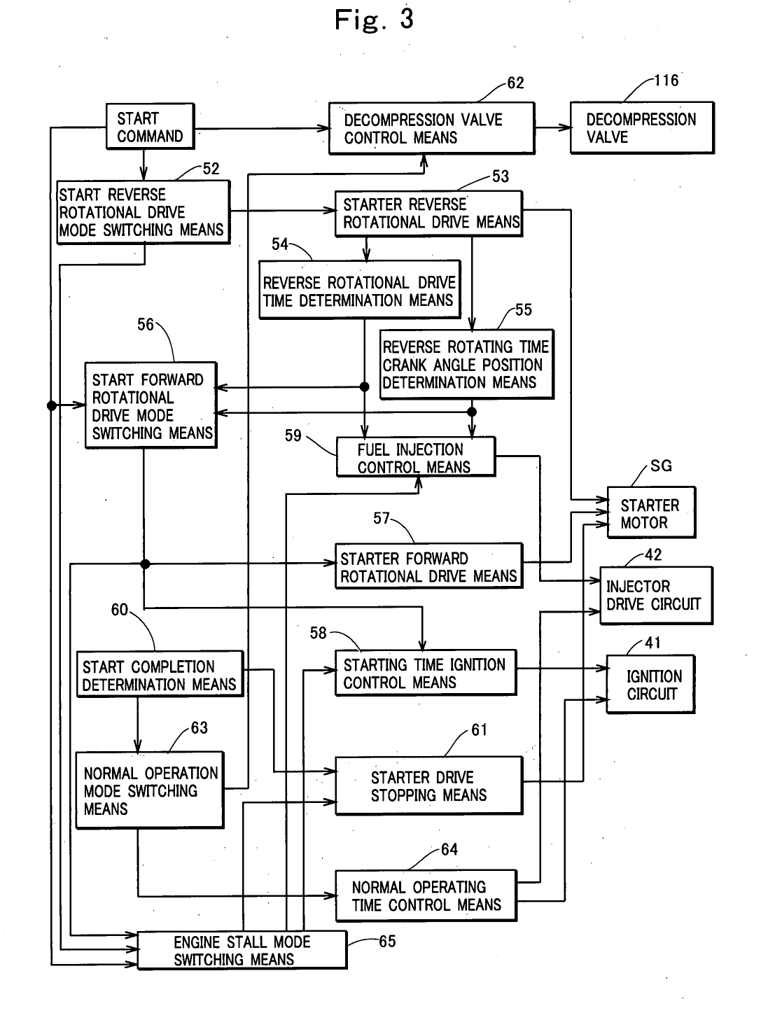

In this embodiment, construction of a principal part of a control device including various kinds of control means which the microprocessor 40 comprises is illustrated in FIG. 3. In FIG. 3, a reference numeral 52 denotes start reverse rotational drive mode switching means for switching a control mode to a start reverse rotational drive mode when a start command for the engine ENG from a starter switch, which is comprised of a key switch, and the like is given, and 53 denotes starter reverse rotational drive means for driving the starter motor SG in a reverse rotational direction so as to reverse the crankshaft of the engine when the control mode is switched to the start reverse rotational drive mode by the start reverse rotational drive mode switching means 52. In addition, a reference numeral 54 denotes reverse rotational drive time determination means for determining whether an elapsed time after starting drive of the starter motor in the reverse rotational direction reaches a set time set in sufficient length of time when the piston in a specific cylinder, which has been stopped near the bottom dead center of the compression stroke at the time of forward rotation of the engine since the engine had stopped, arrives is a set position, and reverse rotating time crank angle position determination means for determining whether the piston in the specific cylinder reaches the set position while the starter motor SG is driven in the reverse rotational direction.

The set position of the piston is set in a proper position in a section corresponding to an intake stroke at the time of forward rotation of the engine (preferably, a position near a top dead center of an intake stroke at the time of forward rotation), or a position passing through the section corresponding to the intake stroke at the time of forward rotation of the engine. Here, “a position passing through the section corresponding to the intake stroke at the time of forward rotation of the engine” may be a position in the section corresponding to an exhaust stroke at the time of forward rotation, or may be a position (for example, a proper position in the section corresponding to an expansion stroke at the time of forward rotation) passing through the section corresponding to the exhaust stroke at the time of forward rotation.

Furthermore, a reference numeral 56 denotes start forward rotational drive mode switching means for switching the control mode to a start forward rotational drive mode when the reverse rotational drive time determination means 54 determines that the elapsed time reaches a set time, or when the reverse rotating time crank angle position determination means 55 determines that the crank angle position arrives in a set position, and 57 denotes starter forward rotational drive means for starting drive of the starter motor SG in the forward rotational direction when the control mode is switched to the start forward rotational drive mode.

A reference numeral 58 denotes starting time ignition control means for causing ignition in a cylinder of the engine to be ignited during a crank angle position of the engine being in a section suitable for performing ignition at the time of start-up in the cylinder, while the starter forward rotational drive means 57 drives the starter motor SG in the forward rotational direction.

A reference numeral 59 denotes fuel injection control means for causing the fuel injection device to perform initial fuel injection for said specific cylinder when the reverse rotational drive time determination means 54 determines that the elapsed time reaches the set time, or when the reverse rotating time crank angle position determination means 55 determines that the crank angle position arrives in the set position, and causing the fuel injection device to perform fuel injection in a crank angle position which is suitable as a position for injecting fuel for generating an air-fuel mixture supplied in a cylinder in which ignition is performed thereafter.

Furthermore, a reference numeral 60 denotes start completion determination means for determining whether a start of the engine is completed, 61 denotes starter drive stopping means for stopping drive of the starter motor SG when the start completion determination means 60 determines that the start of the engine is completed.

A reference numeral 62 denotes decompression valve control means for opening the decompression valve 116 when the start command for the engine is given, and closing the decompression valve 116 when the start completion determination means 60 determines that the start of the engine is completed, 63 denotes normal operation mode switching means for switching the control mode to a normal operation mode when the start completion determination means 60 determines that the start of the engine is completed, and 64 denotes normal operating time control means for controlling a fuel injection amount and an ignition position at the time of an engine normal operation.

The normal operating time control means 64 comprises normal fuel injection control means for arithmetically operating a fuel injection time for various kinds of control conditions at the time of the engine normal operation (after start), and giving an injection command signal to the injector drive circuit 42 so as to make fuel injected from the injector during the injection time which is arithmetically operated, and normal ignition control means for arithmetically operating an ignition position at the time of the engine normal operation and giving an ignition command to the ignition circuit when the ignition position arithmetically operated is detected.

In addition, a reference numeral 65 denotes engine stall mode switching means for switching the control mode to an engine stall mode when it is detected that the start command of the engine is not given in a state that the control mode is switched to the start reverse drive mode, or a state of being switched to the start forward rotational drive mode, and when the start command is given but it is detected that a control system has a certain error. In the engine stall mode, a series of processing necessary for keeping the engine in a stop state, such as stop of driving the starter motor, inhibition of generating an ignition command and an injection command, and the like are performed.

The above-described starter forward rotational drive means 57 is comprised so as to continue driving the starter motor SG in the forward rotational direction while limiting a drive current of the starter motor SG up to an upper limit even when the crankshaft stops before the piston in a specific cylinder reaches a top dead center of a compression stroke in starting the engine.

Hereafter, the details of control performed in the engine starting device according to the present invention will be described.

In the engine starting device according to the present invention, when the start command for the engine is given by a key switch operation or the like, the starter motor SG is driven in a reverse rotational direction in order that an air-fuel mixture is sucked into a cylinder which is ignited first of all at the time of a start, and the crankshaft of the engine is reversely rotated until the piston in a specific cylinder, which has stopped near a bottom dead center of a compression stroke at the time of forward rotation of the engine since the engine had stopped, arrives in a proper position in a section corresponding to an intake stroke at the time of forward rotation of the engine (possibly, a position near a top dead center of an intake stroke), or set in a position passed through the section.

FIG. 5A illustrates a relationship between strokes of two cylinders of a parallel two-cylinder four-cycle engine, and FIG. 5B illustrates a load torque applied to the crankshaft when the crankshaft is rotated from the external. When reversely rotating the crankshaft of the engine, a compression torque of a gas in a cylinder acts on the crankshaft as a load torque in a section corresponding to an expansion stroke at the time of forward rotation. In the parallel two-cylinder four-cycle engine, as illustrated in FIG. 5A, when one cylinder is in an intake stroke, a stroke of another cylinder is an expansion stroke, so when the starter motor is reversely driven at the time of the start to raise a piston of the one cylinder (the first cylinder in the example illustrated in FIG. 5A) stopping near a bottom dead center of a compression stroke toward a top dead center of the intake stroke at the time of forward rotation, a compression torque acts in the another cylinder (the second cylinder in the example illustrated in FIG. 5A) although a compression torque does not act in the one cylinder.

Therefore, when using a starter motor whose output torque is small, it is not possible to make the piston of the one cylinder which has stopped near the bottom dead center of the compression stroke reach a position corresponding to the top dead center of the intake stroke at the time of forward rotation. Therefore, when an engine to be started is the parallel two-cylinder four-cycle engine, the crankshaft stops in a position where the piston of the one cylinder (a first cylinder in the illustrated example) reaches a midway of a section corresponding to the intake stroke at the time of forward rotation as illustrated in FIG. 5B when the crankshaft is reversely rotated.

When the crankshaft stops (before making the crankshaft forwardly rotated), initial fuel injection is performed in preparation for initial ignition in starting-up by giving an injection command signal Vj to the injector drive circuit as illustrated in FIG. 5C.

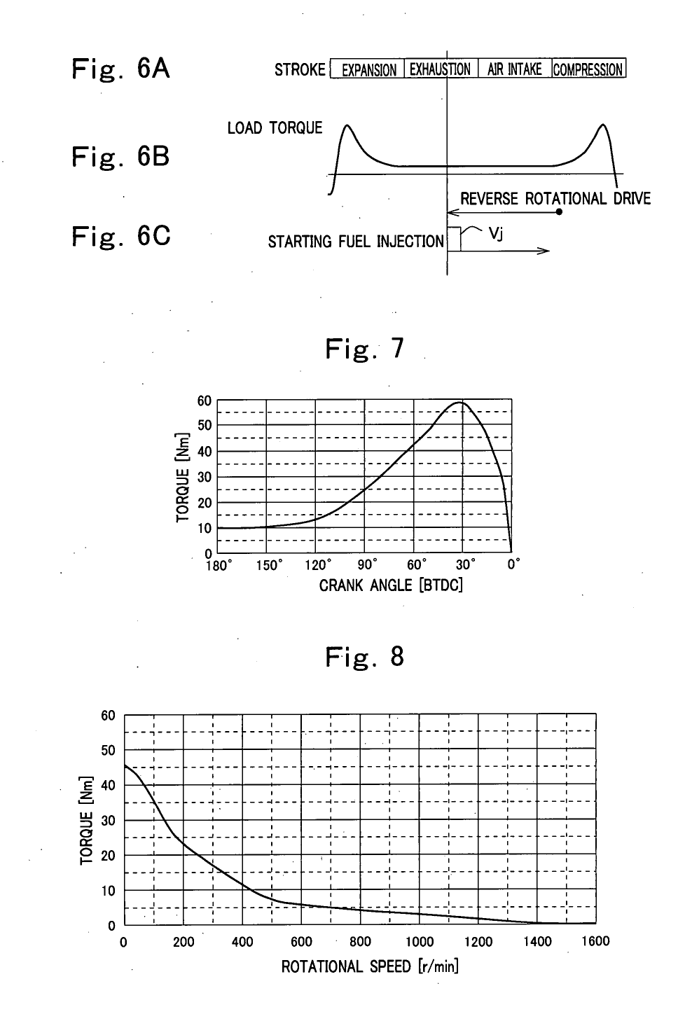

In addition, when an engine to be started is a single-cylinder four-cycle engine, a compression torque does not act on the crankshaft when the starter motor is reversely driven as illustrated in FIGS. 6A and 6B, therefore it is possible easily to reversely rotate the crankshaft up to near a crank angle position corresponding to the top dead center of the intake stroke at the time of forward rotation. Also in this case, when the crankshaft stops (before making the crankshaft forwardly rotated), the fuel injection device is made to perform initial fuel injection in preparation for initial ignition in starting-up by giving the injection command signal Vj to the injector drive circuit as illustrated in FIG. 6C.

Although the reverse drive of the starter motor was performed in response to the start command and the reverse rotation of the crankshaft was performed also in the conventional engine starting device described in Japanese Patent Application Laid-Open Publication No. 2002-332938, an object of reversely rotating the crankshaft once when starting the engine in the conventional starting device was to increase approach length.

On the other hand, in the present invention, a reason why the crankshaft is reversely rotated first of all when the start command is given is not to increase the approach length, but to make an air-fuel mixture sucked into a cylinder in which ignition is performed first when cranking is performed to forwardly rotate the crankshaft. In the present invention, a reason why the crankshaft is reversely rotated first of all when the start command is given is to make an opportunity to inject fuel in preparation for ignition performed first after beginning the starting operation, but not to increase the approach length. Therefore, objects of reversely rotating the crankshaft at the time of the start are completely different between the engine starting device according to the present invention, and the conventional engine starting device.

As described above, when the crankshaft is reversely rotated to the position corresponding to a midway of the intake stroke or the front of the intake stroke at the time of forward rotation, the fuel injection device performs initial fuel injection, and thereafter, the starter motor SG is driven in the forward rotational direction. A relationship between the load torque of the engine and the crank angle at this time is as illustrated in FIG. 7, and a relationship between the output torque and the rotational speed of the starter motor is as illustrated in FIG. 8. In FIG. 7, the crank angle of the horizontal axis illustrates the angle before a top dead center [BTDC], and a crank angle position 0 illustrated is a crank angle position (this is called a top dead center position) corresponding to a top dead center of a piston.

When the starter motor is driven in the forward rotational direction, the output torque of the motor becomes low with increasing of the rotational speed as illustrated in FIG. 8, but the engine load torque becomes large as the crankshaft rotates toward the top dead center position as illustrated in FIG. 7. Here, supposing it is in a situation that the rotational speed cannot be accelerated until the piston obtains inertia energy sufficient for going over the top dead center of a compression stroke because the engine friction torque is large, the crankshaft stops once in the middle of the compression stroke as a curve a illustrated in FIG. 15. Although drive of the starter motor was stopped at this moment in the conventional starting device, the present invention maintains energization on the starter motor even after the starter motor stops, and continues the drive of the starter motor in the forward rotational direction while performing control so as to maximize an output torque of the motor in a range of the drive current (armature current) not exceeding an upper limit.

Generally, in a four-cycle engine, slight compression leakage occurs from a piston ring or intake and exhaust valves while a piston rises toward a top dead center of a compression stroke, so when continuing driving a crankshaft by the starter motor even after the crankshaft stops, a compression torque decreases over time and an engine load torque gradually decreases. Therefore, when continuing driving the starter motor even after the starter motor cannot overcome the engine load torque (sum of compression torque and friction torque) and stops, the piston rises slowly accompanying gradual decrease of the load torque due to the compression leakage, and the crankshaft rotates at crawling speed. In a short time, when a rotational angle position of the crankshaft exceeds a compression torque maximum position (a position near a position 30° ahead of a top dead center of a compression stroke in the example illustrated in FIG. 7) before a crank angle position (position at 00) corresponding to the top dead center of a compression stroke, an engine load torque becomes light and the load applied to the starter motor from the engine becomes light, and therefore, the crankshaft starts to rotate with increasing speed. Therefore, the piston can go over the top dead center of the compression stroke easily.

While the starter forward rotational drive means drives the starter motor in the forward rotational direction, ignition is performed in a cylinder, which should be ignited, while a crank angle position of the engine exists in a section suitable for performing ignition at the time of a start in each cylinder of the engine.

Although in the conventional engine starting device, initial ignition in starting-up was performed in a position before the top dead center of the compression stroke at the time of forward rotation, in the present invention, the top dead center of the compression stroke is made gone over by rotating the crankshaft at crawling speed, so if the initial ignition is performed in the crank angle position ahead of the top dead center, there is a possibility that the piston may be put back and the engine may be reversed. Therefore, it is preferable to make initial ignition in starting-up of the engine performed in a crank angle position at the time when the piston reaches the top dead center of the compression stroke, or a position (a crank angle position in an initial stage of an expansion stroke at the time of forward rotation) passed through the crank angle position corresponding to the top dead center of the piston, by a fixed angle (for example, 10°).

When initial ignition in starting-up of the engine is caused in the crank angle position at the time when the piston reaches the top dead center of the compression stroke, or the position passed through the crank angle position corresponding to the top dead center of the piston by the fixed angle, it is possible not only to prevent the piston from rebounding, but also to burn fuel in the cylinder ignited and to make an expansion stroke performed. Therefore, the crankshaft rotates at an accelerated rate by a resultant force of a driving force of the starter motor, and a rotating force generated by combustion (explosion) generated in the cylinder. The starter forward rotational drive means makes inertial energy accumulated at a stretch by this rotation and makes the compression stroke of the following cylinder performed, and subsequently, makes ignition performed in the cylinder to make the expansion stroke performed. Hereafter, the starter forward rotational drive means makes fuel injection and ignition performed repeatedly and makes a combustion cycle performed in each cylinder, and thereby, raises the rotational speed of the crankshaft to complete the start-up of the engine.

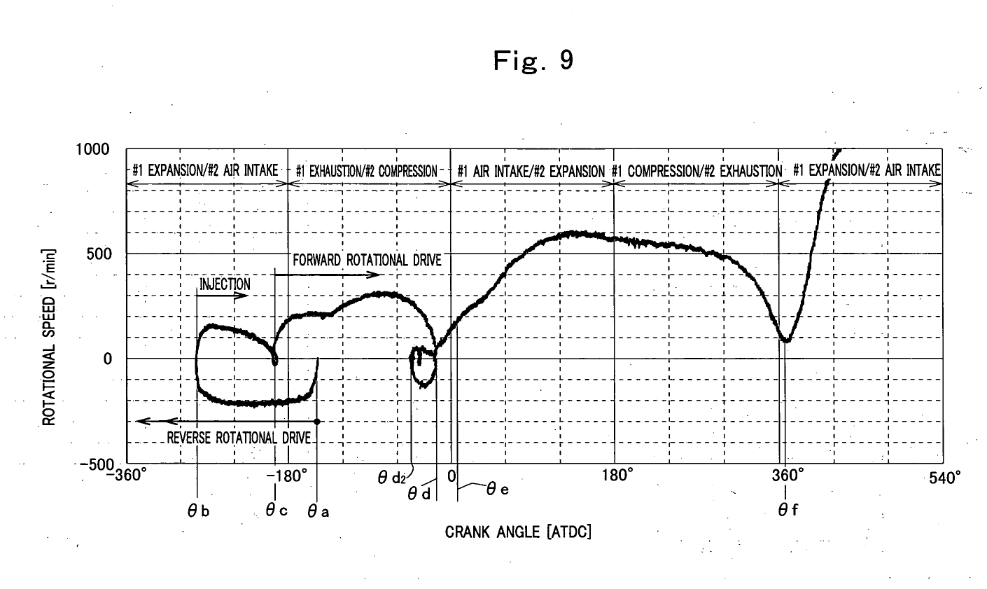

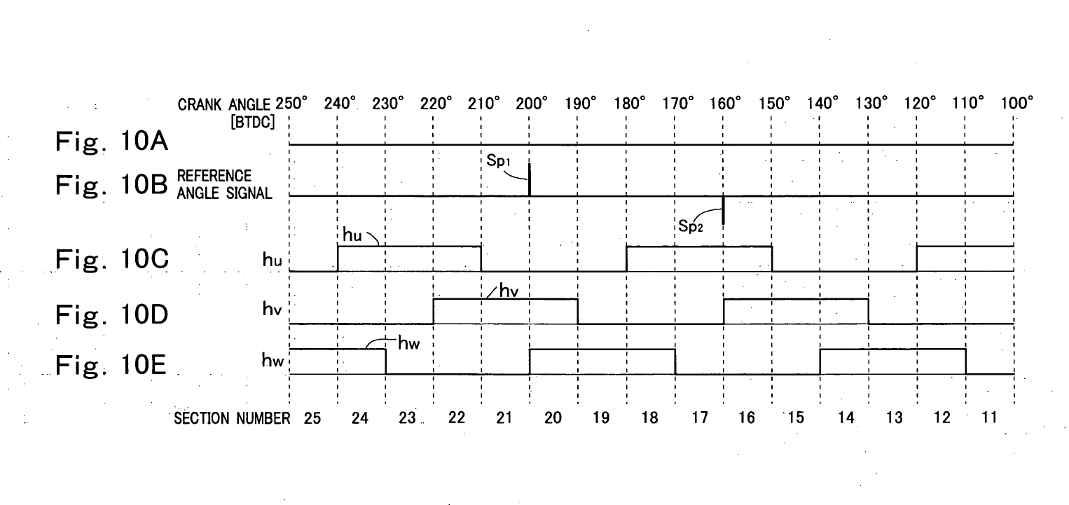

FIG. 9 illustrates a relationship between the rotational speed of the crankshaft at the time of a start and the crank angle which were measured in the experiment by the inventor. Description of “#1 expansion/#2 air intake” and the like illustrated in a topmost part of FIG. 9 denotes strokes of a first cylinder and a second cylinder at the time of forward rotation of the engine, and for example, it means that a section displayed as “#1 expansion/#2 air intake” means that the first cylinder is in an expansion stroke, and the second cylinder is in an intake stroke. The angle graduated in the horizontal axis of FIG. 9 is shown with making the top dead center of a compression stroke of the second cylinder 0°, and the angle of each crank angle position to this top dead center is shown with making a side [ATDC], which is after the top dead center, positive.

In the example illustrated in FIG. 9, the engine is stopped in a state that a piston in the second cylinder of the engine is in a crank angle position θa near a bottom dead center of a compression stroke at the time of forward rotation. Temperature when the engine is stopped is −40° C.

When a start command is given in this state, the decompression valve control means 62 illustrated in FIG. 3 opens the decompression valve 116, and therefore, pressure leakage in the compression stroke of each cylinder becomes large. In addition, because the start reverse rotational drive mode switching means 52 makes the control mode the start reverse rotational drive mode, the starter reverse rotational drive means 53 drives the starter motor SG in the reverse rotational direction to reversely rotate the crankshaft. Thereby, the crankshaft rotates toward a section corresponding to an intake stroke of the second cylinder at the time of forward rotation from a crank angle position corresponding to a bottom dead center of the compression stroke of the second cylinder. When the crank angle position enters into the section corresponding to the intake stroke of the second cylinder at the time of forward rotation, the first cylinder enters into a section corresponding to the expansion stroke at the time of forward rotation, and therefore, a large load torque acts from the first cylinder to the crankshaft. Therefore, the crankshaft can rotate only to the crank angle position θb in the middle of the section corresponding to the intake stroke at the time of forward rotation of the second cylinder, and therefore, it stops at this crank angle θb. Let this crank angle position θb be a reverse rotational drive end position.

In this embodiment, when the reverse rotational drive time determination means 54 determines an elapsed time from a time when drive in the reverse rotational direction is started exceeds a set time, or when the reverse rotating time crank angle position determination means 55 determines that a crank angle position coincides with the crank angle position θb set beforehand, it is determined that the crank angle position arrives in the forward rotational driving start position θb.

When it is determined that the crank angle position arrives in the reverse rotational drive end position θb, the drive of the starter motor is stopped to secure an injector drive voltage, and thereafter, when the fuel injection control means 59 gives an injection command to the injector drive circuit 42 for ignition performed first after performing forward rotation of the crankshaft, initial fuel injection is performed from the injector.

Because the drive of the starter motor has stopped in the meantime (until the injection is completed), the crankshaft is put back by a compressive reaction of the first cylinder, moves to the illustrated θc position, and stops. When the initial fuel injection from the injector is completed, the start forward rotational drive mode switching means 56 makes the control mode the start forward rotational drive mode, and therefore, the ignition control means 58 starts detection of an ignition position at the time of a start at the same time when the starter forward rotational drive means 57 starts drive of the starter motor SG in the forward rotational direction.

When the starter forward rotational drive means 57 drives the starter motor from the position θc to a forward direction and the crank angle position approaches the top dead point position (position of 0°) of the compression stroke of the second cylinder, the load torque acting on the crankshaft becomes large and rotational speed drops, and therefore, the crankshaft is rebounded in a crank angle position θd before the crank angular position where a load torque (compressive reaction of the second cylinder) becomes maximum, and it stops in a position of θd2. Here, when it is continued to supply a drive current to the starter motor and to drive the motor in the forward rotational direction, the load torque acting on the crankshaft by the compression leakage of the second cylinder gradually decrease, and therefore, the crankshaft starts to rotate in the forward direction again, and when the crank angle position passes a maximum position of the load torque which is before the top dead point position (position of 0°) of the compression stroke of the second cylinder, the crankshaft is accelerated.

In the example illustrated in FIG. 9, it is made to define a position θe that a crank angle position passed by 10° from the top dead center position of the second cylinder as an ignition position at the time of a start, to detect this ignition position by the ignition control means 58, and to perform initial ignition in the second cylinder when the ignition position θe is detected. Because an air-fuel mixture combusts in the second cylinder by this ignition and an expansion stroke is performed, rotational speed of the crankshaft is accelerated at a stretch. When the crankshafts rotate by 180° from the top dead center (position of 0 degree) of the compression stroke in the second cylinder, the first cylinder enters into a compression stroke, and therefore, the load torque acting on the crankshaft increases. Although the rotational speed of the crankshaft drops because of increase of this load torque, inertial energy is enough stored by the combustion already performed in the second cylinder, so that the crankshaft does not stop before the top dead center of the compression stroke of the first cylinder. In the illustrated example, initial ignition of the first cylinder is performed in a crank angle position θf that the crank angle position passes by 10° from the top dead center position of the compression stroke in the first cylinder.

In addition, when a friction torque is large, the crankshaft may stop before the top dead center position of the compression stroke of the first cylinder, but also in that case, the starter forward rotational drive means 57 continues to drive the starter motor, and it is possible to rotate the crankshaft again by using gradual decrease of the load torque by the compression leakage, and therefore, ignition in the crank angle position Of is performed without a hitch.

When ignition in the second cylinder and the first cylinder is repeated as described above, rotational speed of the engine increases gradually, and even if the drive of the starter motor is stopped in a short time, the engine can maintain rotation, and therefore, the start of the engine is completed. When the start completion determination means 60 determines that the start of the engine is completed, the starter drive stopping means 61 stops the drive of the starter motor SG. At this time, because the normal drive mode switching means 63 makes the control mode the normal drive mode, the normal operating time control means 64 makes control of the ignition device and control of the fuel injection device transfer to control at the time of a normal operation. In addition, the decompression valve control means 62 closes the decompression valve 116 to prevent the decompression hole from affecting the engine output at the time of the normal operation.

Determination (determination of whether start of the engine is completed) of whether the engine comes to rotate by itself can be performed by confirming that the crankshaft performs the predetermined number of rotations with average rotational speed exceeding a start decision value set beforehand.

In the above described control, in order to determine whether a rotational angle position of the crankshaft reaches a target reverse rotational drive stop position θb when the starter motor is driven in the reverse rotational direction, information on a crank angle position of the engine is needed. In addition, also when detecting the ignition position θe at the time of the start-up, the information on the crank angle position is needed. Furthermore, also when detecting a crank angle position where fuel injection is performed to a cylinder, the information on the engine crank angle position is needed. In control of the normal operation, when detecting an ignition position arithmetically operated, and when determining a fuel injection starting position, the information on the engine crank angle position is needed.

In the conventional engine control device, although it was frequent to obtain the engine crank angle information from an output of a signal generator which detected a reluctor provided in a rotor rotating with an engine and generated a pulse signal, this kind of signal generator cannot generate a pulse with a high peak value when rotational speed of the crankshaft is low, therefore it is not optimum as a signal source which obtains crank angle information at very low speed of the engine (for example, 200 r/min or less).

Then, in this embodiment, on the basis of obtaining crank angle information from detection signals which the three-phase hall sensors 29u to 29w provided in the starter generator SG output, an output pulse of the signal generator 28 is used only for identifying whether a rotational angle position detected from an output of a hall sensor corresponds to any crank angle position of the engine.

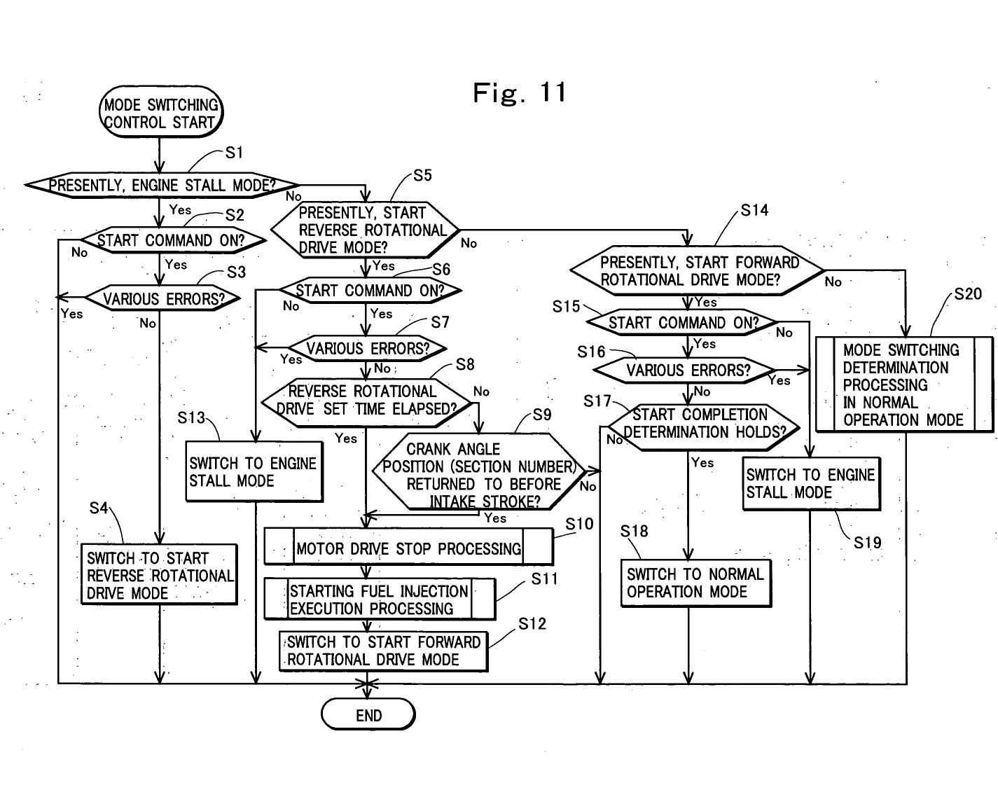

In the case where a 12-pole (six pair-electrodes) of magnet rotor is used as a rotor of an electric rotating machine, when hall ICs are used as the three-phase hall sensors 29u to 29w, waveforms of the position detection signals hu to hw which the sensors 29u to 29w generate respectively become as illustrated in FIG. 10C to 10E, and therefore, any one of the position detection signals hu to hw shows a change from a high level (H level) to a low (L level) or a change from a low level to a high level whenever the crank angle changes by 10°. In this embodiment, the H level and the L level of these position detection signals hu to hw are expressed by “1” and “0” respectively, a series of sections are detected from changes of patterns of levels of the position detection signals by making a 10° section one section, and it is identified by using the output pulse of the signal generator 28 whether these sections correspond to any engine crank angle positions.

In this embodiment, in order that the signal generator 28 can generate a pulse with a peak value as high as possible at the time of a start, the reluctor r is detected to generate a pulse by the signal generator 28 in the section which has a piston near a bottom dead center and where engine load torque is relatively light. Specifically, as illustrated in FIG. 10B, the signal generator 28 is arranged so that the signal generator 28 may detect a front edge and a rear edge of the reluctor r in a rotational direction respectively in a position of 200°, and a position of 160° before the top dead center of the compression stroke of the second cylinder and may generate a pulse Sp1 of positive polarity and a pulse Sp2 of negative polarity.

From the pulses Sp1 and Sp2 which the signal generator 28 outputs, it is identified whether a series of sections detected by the changes of the output patterns of the hall sensors correspond to any engine crank angles respectively. In the illustrated example, as illustrated in the bottom of FIG. 10, it is made to assign a section number of “20” to a 10° section (a section from a position where a pattern of the position detection signals hu, hv, and hw becomes 0, 1, and 1 to a position where the pattern becomes 0, 0, and 1) detected immediately after the signal generator 28 generates the pulse Sp1, to make the section number increased or decreased by 1 whenever the patterns of the outputs of the hall sensors change hereafter, and to assign the section numbers of 1 to 72 to 72 sections detected while the crankshaft rotates two times.

Once a relationship between the series of sections, which are detected from the change of the patterns of the outputs of the hall sensors, and the current engine crank angle position can be identified, it is possible to maintain correspondence between each section and a crank angle position of the engine by making the section number increased or decreased by 1 whenever the patterns of the outputs of the hall sensors change hereafter.

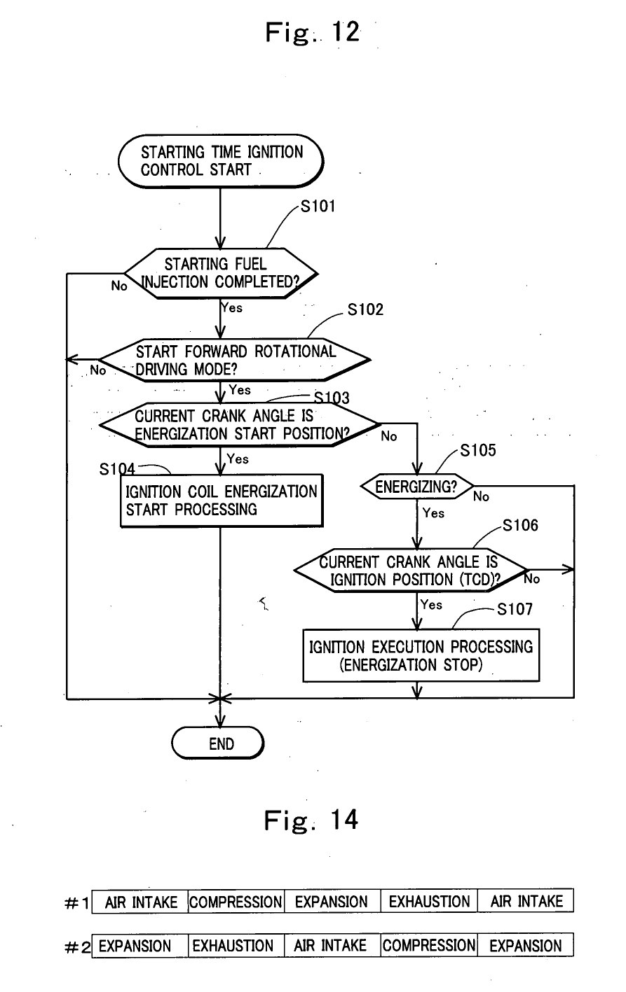

In the control device illustrated in FIG. 3, flowcharts illustrating algorithms of task operations which the microprocessor executes so as to control switching of the control mode at the time of transferring to a normal operation state from a start time are illustrated in FIGS. 11 and 12.

When a power supply is established, the microprocessor repeatedly executes the task operation in FIG. 11 in minute intervals to manage switching of the control mode. According to the illustrated algorithm, first of all, the microprocessor determines at step S1 whether a current control mode is the control mode when the engine is stopped (engine stall mode). In consequence, when determining that it is the engine stall mode, the microprocessor determines whether a start command is given at step S2 subsequently. In consequence, when determining that the start command is not given, it ends this task without doing anything hereafter, and when determining that the start command is given, it transfers the process to step S3 and checks whether various kinds of errors (abnormality of a sensor, and the like) arise. In consequence, when determining that an error arises, it ends this task without doing anything, and when determining that an error does not arise, it switches the control mode to the start reverse rotational drive mode at step S4, and ends this task. The microprocessor not only opens the decompression valve 116 by another task operation started when the control mode is switched to the start reverse rotational drive mode, but also controls energization to the three-phase armature coil of the electric rotating machine SG so as to rotate its rotor in the reverse rotational direction by making the electric rotating machine SG operate as a brushless motor.

When determining that the current control mode is not the engine stall mode at step S1 of the task in FIG. 11, it transfers the process to step S5 and determines whether the current control mode is the start reverse rotational drive mode. In consequence, when determining that it is the start reverse rotational drive mode, the microprocessor determines whether the start command is given at step S6, and when determining that the start command is given, it transfers the process to step S7 and determines whether various kinds of errors arise. In consequence, in the case of being errorless, after starting drive of the starter motor in the reverse rotational direction, it determines at step S8 whether the reverse rotational drive set time has elapsed. When determining at step S8 that the reverse rotational drive set time has not elapsed, it determines at step S9 whether the current crank angle position (section number) returns to the position in the middle of the section corresponding to the intake stroke at the time of forward rotation, or the reverse rotational drive end position θb set in the position corresponding to the position before starting the intake stroke at the time of forward rotation. In consequence, when determining that the current crank angle position does not return to the reverse rotational drive end position, it ends this task without doing anything hereafter.

When determining at step S8 that the reverse rotational drive set time has elapsed, and when determining at step S9 that the current crank angle position is the reverse rotational drive end position, it transfers the process to step S10 and performs processing of stopping the drive of the starter motor SG. After stopping the drive of the starter motor and securing a drive voltage of the injector, the microprocessor executes step S11 and makes initial fuel injection performed in preparation for initial ignition at the time of a start. Then, it switches the control mode to the start forward rotational drive mode at step S12, and ends this task. Starting injection execution processing in which initial fuel injection for a start is performed at step S11 is performed by another task operation, which is started, when being determined at step S8 that the reverse rotational drive set time has elapsed, and when being determined at step S9 that the current crank angle position is the reverse rotational drive end position. In addition, when the control mode is switched to the start forward rotational drive mode at step S12, a task operation which controls energization to the armature coil so as to make the rotor of the electric rotating machine SG forwardly rotated and which is not illustrated starts, and therefore, the starter motor is driven in the forward rotational direction. When determining at step S6 that the start command is not given, and when determining at step S7 that an error arises, the microprocessor transfers the process to step S13 and makes the control mode the engine stall mode. When the control mode is switched to the engine stall mode, a task not illustrated is started, and performs a series of processings necessary for keeping the engine in a stop state, such as a drive stop of the starter motor, inhibition of generating an ignition command and an injection command, and the like.

When determining at step S5 that the current control mode is not the start reverse rotational drive mode, it transfers the process to step S14 and determines whether the current control mode is the start forward rotational drive mode. In consequence of this determination, when determining that the control mode is the start forward rotational drive mode, the microprocessor determines at step S15 whether the start command is given, and when determining that the start command is given, it determines at step S16 whether various kinds of errors arise. In consequence, when determining that an error does not arise, the microprocessor determines at step S17 whether a start completion command is met, and when being met, it makes the control mode into the normal operation mode and completes this task at step S18.

When determining at step S15 that the start command is not given, and when determining at step S16 that various types errors arise, the microprocessor transfers the process to step S19 and switches the control mode to the engine stall mode. In addition, when determining at step S14 that the current control mode is not the start forward rotational driving mode, it advances the process to step S20 and makes switching of the control mode in the normal operation mode performed.

In the normal operation mode, by a task operation other than the processing illustrated in FIG. 11, it executes not only processing for closing the decompression valve 116, but also processing for comprising the normal fuel injection control means and the normal ignition control means which control the fuel injection device and the ignition device respectively. The fuel injection control means arithmetically operates a fuel injection amount necessary for obtain a predetermined air-fuel ratio in relation to various kinds of control conditions, and gives an injection command, which has a signal width necessary for injecting the amount of fuel, arithmetically operated, in a proper injection starting position, such as a crank angle position just before starting an intake stroke, to the injector drive circuit 42. In addition, the normal ignition control means comprises ignition position arithmetical operation means for arithmetically operating an engine ignition position in relation to various kinds of control conditions, and means for detecting the ignition position arithmetically operated, and gives an ignition command signal to the ignition circuit to make an ignition operation performed when detecting the ignition position which the ignition position arithmetical operation means arithmetically operated. The ignition position arithmetical operation means arithmetically operates a time necessary for the crankshaft rotating with the current rotational speed from a reference crank angle position, defined beforehand, to an ignition position as timing data for ignition position detection. Then, when the reference crank angle position (section number) defined beforehand is detected, the ignition position arithmetical operation means starts measurement of the timing data for ignition position detection arithmetically operated, and when the measurement of this timing data is completed, it gives an ignition command signal to the ignition circuit 41 to make an ignition operation performed. In addition, so as to keep the engine idling speed constant, it gives a drive voltage Visc to the ISC valve 120 from the ISC valve drive circuit 43 to control the ISC valve.

When the control mode is switched to the start forward rotational driving mode at step S12 in FIG. 11, interrupt handling in FIG. 12 is allowed, and whenever the patterns of the output signals of the hall sensors 29u to 29w change (whenever the section number changes), the interrupt handling in FIG. 12 is executed. The ignition position arithmetical operation means detects the crank angle position corresponding to the top dead center of a compression stroke or the position passed through the crank angle position corresponding to the top dead center of the piston by the fixed angle as an ignition position at the time of a start by the interrupt handling in FIG. 12, and makes an ignition operation at the time of a start performed in this ignition position. In the example illustrated in FIG. 12, the top dead center of the compression stroke is determined as the ignition position at the time of the start-up.

In the interrupt handling in FIG. 12, it is determined first of all at step S101 whether starting fuel injection is completed. In consequence, when determining that the starting fuel injection is not completed, the microprocessor ends this task without doing anything hereafter. When determining that the starting fuel injection is completed, it transfers the process to step S102 and determines whether the control mode is the start forward rotational driving mode. In consequence, when not being the start forward rotational driving mode, it completes this processing without doing anything hereafter, and when being a start forward rotational driving mode, it advances the process to step S103 and determines whether the current crank angle position (section number) is an energization start position which starts energization to the ignition coil 13. In consequence, when determining that it is the energization start position, it advances the process to step S104, and starts energization to a primary coil of the ignition coil 13 to complete this processing. When determining at step S103 that the current crank angle position (section number) is not the energization start position, it transfers the process to step S105 and determines whether energization to the primary coil of the ignition coil is performed. In consequence, when determining that the energization is not performed, it ends this processing without doing anything hereafter, and when determining that the energization is performed, it transfers the process to step S106 and determines whether the current crank angle position is the ignition position at the time of a start (in this example, a top dead center TDC of a compression stroke). When determining at step S106 that the current crank angle position is not the ignition position at the time of a start, it ends this processing without doing anything hereafter, and when determining that the current crank angle position is the ignition position at the time of a start, it executes ignition execution processing at step S107. In the ignition execution processing at step S107, the microprocessor makes energization of the primary current of the ignition coil 13 stopped to make a high voltage for ignition induced in the secondary coil of the ignition coil induced, and thereby, makes a spark discharge generated by an ignition plug to ignite the engine.

In this embodiment, the start reverse rotational drive mode switching means 52 is comprised at steps S1 to S4 in FIG. 11, and the reverse rotational drive time determining means 54 and the reverse rotational crank angle position determining means 55 are comprised at steps S8 and S9, respectively. In addition, the fuel injection control means 59 is comprised at step S11, and the start forward rotational drive mode switching means 56 is comprised at step S12. Furthermore, the start completion determination means 60 is comprised at step S17, and the normal operation mode switching means 63 is comprised at step S18. In addition, the engine stall mode switching means 65 is comprised at steps S1 to S3, S13, S14 to S16, and S19 in FIG. 11, and the starting time ignition control means 58 is comprised in the processing of FIG. 12.

When such a decompression hole is provided in the cylinder head of the engine as the above described embodiment, because an air-fuel mixture in the cylinder leaks out through the decompression hole while the piston is displaced slowly toward the top dead center of the compression stroke, it is possible to make the piston go over a maximum position of a compression torque in a short time by urging a drop of the compression torque due to compression leakage, and it is possible to enhance engine startability. However, in the engine, since slight compression leakage arises from a piston ring or intake and exhaust valves, it is possible to make the starting device of the present invention function without providing the decompression hole especially.

In the case where the decompression hole is provided, although it is preferable to provide the decompression valve which opens and closes the decompression hole, and to close the decompression hole after start of an engine is completed as the above described embodiment, when an inner diameter of the decompression hole is sufficiently small, an amount of a gas which leaks at the time of a normal operation through the decompression hole is very slight and an influence of the decompression hole on an output of the engine at the time of a normal operation is slight, and therefore, the decompression valve may be omitted.

In the above described embodiment, although the invention is applied to the engine starting device which starts a parallel two-cylinder four-cycle engine, the invention also can apply to the engine starting device which starts a single-cylinder four-cycle engine and a three-cylinder or more of multi-cylinder four-cycle engine.

In the above-described embodiment, although the initial fuel injection is performed in the reverse rotational drive end position θb, the present invention is not limited to the above-described embodiment. For example, it is also sufficient to make initial fuel injection performed in a position advanced a little bit toward a forward rotation side from the reverse rotational drive end position θb.

When the decompression hole is provided in the cylinder head of the engine as the above described embodiment, an air-fuel mixture in the cylinder leaks out through the decompression hole while the piston is displaced slowly toward the top dead center of the compression stroke, therefore it is possible to make the piston go over a maximum position of a compression torque in a short time by urging a drop of the compression torque, and it is possible to enhance engine startability. However, in the engine, because slight compression leakage arises from a piston ring or intake and exhaust valves, it is possible to function the device of the present invention without providing a decompression hole.

In the case where the decompression hole is provided, although it is preferable to provide the decompression valve which opens and closes the decompression hole, and to close the decompression hole after the start of the engine is completed as the above described embodiment, when an inner diameter of the decompression hole is sufficiently small, an amount of a gas which leaks at the time of a normal operation through the decompression hole is very slight and an influence of the decompression hole on an output of the engine at the time of a normal operation is slight, and therefore, the decompression valve may be omitted.

When starting the engine in a state that a friction torque is large, it is preferable to rotate the crankshaft in the reverse direction by reversely rotating the starter motor in response to the start command for the engine as the above described embodiment, and to make an opportunity of performing initial fuel injection for ignition in a cylinder, in which a compression stroke is performed first after beginning a start. But when the friction torque at the time starting the engine does not become so large, and when a dropping part of a compression torque generated by compression leakage while the engine piston is displaced slowly toward the top dead center of the compression stroke is relatively large, for example, when the decompression valve 116 is provided, even if the friction torque is large, it is possible to overcome the compression stroke relatively easily by continuing driving the starter motor when the crankshaft is in a stopped state or just before stopping in the compression stroke performed at the time of starting the engine. In such a case, even if the starter motor is made to be forwardly rotated from the beginning, it is possible to start the engine.

In this case, a cylinder which passes a compression stroke at an initial rotation of a crankshaft after a start command is given cannot be supplied with an air-fuel mixture and therefore cannot be ignited to burn in the cylinder. However, in a cylinder which is to pass a compression stroke at the second rotation of the crankshaft, an air-fuel mixture can be supplied into the cylinder by causing initial fuel injection in an adequate section, and therefore the engine can successfully be started by causing ignition when a rotational angle, position of the crankshaft reaches a position suitable as an ignition position of the cylinder which passes the compression stroke in the second rotation of the crankshaft after the start-up.

Therefore, in the engine starting device according to the present invention, although it is a preferable requirement to have the starter reverse rotational drive means for once reversing the starter motor when the start command is given in order to enable a start of the engine whose friction torque in starting is large, it is not an indispensable requirement, and when ambient temperature expected at the time of a start is not extremely low, or when a decompression hole is provided, it is also possible to omit the starter reverse rotational drive means.

In the above-described embodiment, it is also possible to comprise the starting time ignition control means 58 so as to make multiple ignition performed in a cylinder, which should be ignited, whenever it is detected that a crank angle position enters into an ignition operation suitable section (a section suitable for performing ignition at the time of a start in each cylinder) in each cylinder. A suitable section for performing ignition operation of each cylinder is a section where combustion generated by ignition performed in each cylinder acts effectively to start the engine. The suitable section for performing ignition operation of each cylinder is a section, for example, a starting point of which is a top dead center position (a crank angle position at the time of a piston of each cylinder reaching at a top dead center) of each cylinder is made, and an end point of which is a crank angle position at the time when a crankshaft rotates by 90° from the top dead center position of each cylinder.

In FIG. 2, the ignition device is comprised of the ignition coil 13 provided for each cylinder, and the ignition circuit 41 which controls a primary current of the ignition coil of each cylinder. Here, a current blocking type circuit shall be used as the ignition circuit 41. The current blocking type ignition circuit 41 is a well known circuit comprising a primary current control switch which turns a primary current of an ignition coil on and off in response to a rectangular-wave ignition control signal given from ignition control means Vi. The ignition circuit 41 flows a primary current through a corresponding ignition coil by turning on the primary current control switch when the rectangular-wave ignition control signal Vi is given, and cuts off the primary current of the ignition coil by turning off the primary current control switch, when the ignition control signal Vi is extinguished, to make a high voltage for ignition induced in a secondary coil of the ignition coil. Thus, timing when the ignition control signal Vi is given to the ignition circuit 41 is energization start timing of the primary current of the ignition coil, and timing when the ignition control signal Vi is extinguished is ignition timing.

The starting time ignition control means 58 gives the ignition control signal Vi to the ignition circuit 41 to flow the primary current through the ignition coil in predetermined energization start timing when a crank angle position of the engine is before ignition timing of each cylinder, and cuts off the primary current of the ignition coil by extinguishing the ignition control signal Vi when the ignition timing of each cylinder is detected. The energization start timing and the ignition timing of each cylinder at the time of starting the engine are detected on the basis of timing when the output patterns of the hall sensors illustrated in FIG. 10 changes. For example, switching timing of the output patterns of the hall sensors corresponding to a top dead center position of a compression stroke of each cylinder is used as the energization start timing for each cylinder, and the next switching timing (timing which is behind the energization start timing by 10°) of the output patterns of the hall sensors is made initial ignition timing of multiple ignition for each cylinder.

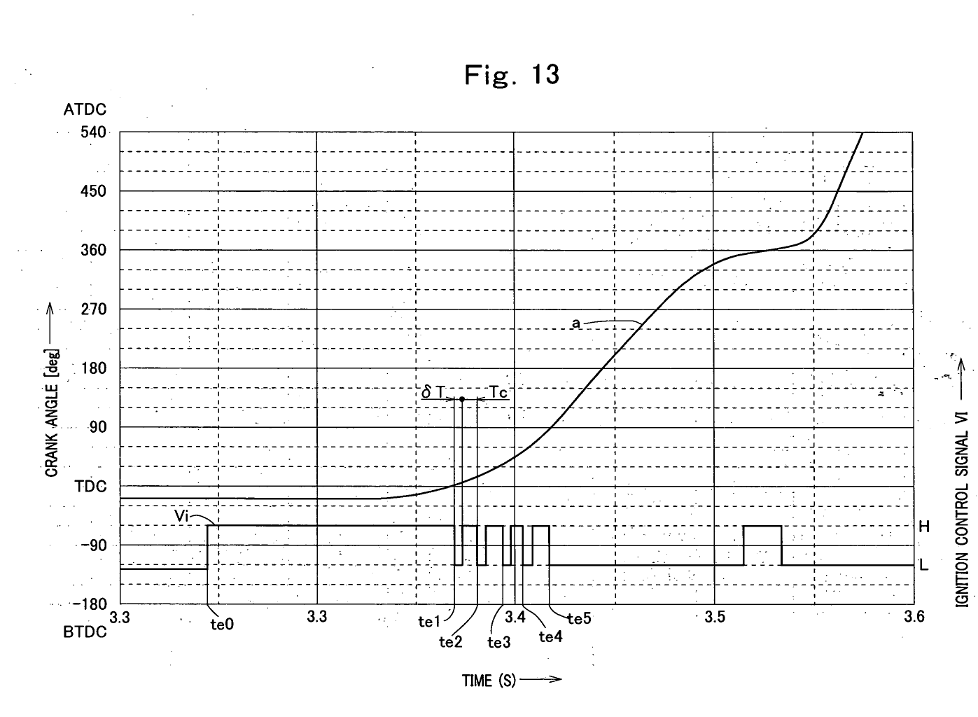

FIG. 13 is a time chart for describing a multiple ignition operation which the ignition device is made to perform, and the horizontal axis of this drawing denotes the time [sec], and the vertical axis denotes the crank angle [deg]. A curve a in FIG. 13 illustrates the temporal response of the crank angle position when the engine starts, and Vi illustrates an ignition control signal given to the ignition circuit. In this example, the ignition circuit 41 is comprised so as to flow the primary current to the ignition coil for a cylinder, which should be ignited, when the ignition control signal Vi is an H level, and to cut off the primary current of the ignition coil concerned, when the ignition control signal Vi is made into an L level, to make an ignition operation performed.

In the example illustrated in FIG. 13, a timing corresponding to a crank position (BTDC20°) advanced from a top dead center position of a cylinder to be ignited by about 200 is set as energization start timing te0, and the starting time ignition control means 58 generates the ignition control signal Vi in this energization start timing to flow the primary current into the ignition coil for the cylinder to be ignited. The starting time ignition control means 58 extinguishes the ignition control signal Vi in ignition timing te1 corresponding to the top dead center position to perform initial ignition. After waiting for a stand-by time δT corresponding to a duration (about 500 μs) of spark discharge generated in an ignition plug in the ignition timing te1 (after keeping the ignition control signal Vi at the L level), the ignition control signal Vi is generated and energization is made to resume for the following ignition. After resuming the energization, the ignition control signal Vi is extinguished in the timing te2 when a predetermined energization time Tc elapses, and a second ignition operation is performed. In the same way, energization and cutoff of the primary current are repeated, ignition operations are performed in ignition timings te2, te3 . . . te5.

Although the energization time Tc for making the second and later ignition, which are multiple ignition, performed may be constant, it is also sufficient to detect a voltage of a power supply (in this example, a battery) which flows the primary current through an ignition coil, and to determines the energization time according to the detected supply voltage (the higher the battery voltage is, the shorter the energization time Tc is). In the illustrated example, although five ignition operations are performed one by one for the multiple ignition to be performed, the number of times of making the ignition operations performed is arbitrary. Rotational speed of a crankshaft at the time of passing through near a top dead center position of each cylinder becomes very slow when starting an engine, therefore it is possible to perform multiple times of ignition within an ignition operation suitable section of each cylinder, after fully securing the energization time Tc for supplying primary current to the ignition coil.

The following three kinds of aspects are supposed as those of the above described multiple ignition.

(a) To repeat ignition operations in a range of being able to secure a necessary energization time during from an instant, when a crank angle position of the engine enters into an ignition operation suitable section of each cylinder, to an instant when a predetermined time (fixed value defined beforehand) elapses.

(b) To make ignition operations repeatedly performed in sections after a crank angle position used as a starting point of the ignition operation suitable section of each cylinder, and to stop an ignition operation when a crank angle position used as an end point of the ignition operation suitable section is detected.

(c) To repeat ignition operations only by the number of times set beforehand after a crank angle position used as a starting point of the ignition operation suitable section of each cylinder is detected without limiting a time or a crank angle range when the multiple ignition is performed.

When the stand-by time 8T and the energization time Tc are constant, the numbers of times of ignition at the time of performing multiple ignition become the same in the cases of the above-described (a) and (b).

When multiple ignition is caused in a cylinder, which should be ignited, whenever it is detected that a crank angle position of the engine enters into an ignition operation suitable section in each cylinder while a crankshaft is forwardly rotated after once reversely rotated as described above, it is possible to increase opportunities to ignite an air-fuel mixture. Therefore, even when the rotational speed of a crankshaft at the time of start-up is slow and the air-fuel ratio distribution of the air-fuel mixture in a cylinder cannot be equalized, it is ensured that combustion can be reliably performed after the commencement of the start-up in each cylinder to reliably start the engine.

Although the preferred embodiments of the invention have been described and illustrated with reference to the accompanying drawings, it will be understood by those skilled in the art that these are by way of examples, and that various changes and modifications may be made without departing from the spirit and scope of the invention, which is defined only to the appended claims.

What is claimed is:

1. An engine starting device which starts an engine including at least one cylinder in which a piston is provided, a crankshaft connected to the piston in the cylinder, a fuel injection device which injects fuel in order to generate an air-fuel mixture supplied into the cylinder, an ignition device which ignites the air-fuel mixture compressed in the cylinder, and a starter motor which rotationally drives the crankshaft, comprising:
starter forward rotational drive means for driving the starter motor in a forward rotational direction in order to start the engine;
starting time fuel injection control means for causing the fuel injection device to inject fuel for generating an air-fuel mixture supplied into a cylinder of the engine in preparation for ignition performed in the cylinder of the engine after the starter forward rotational drive means starts drive of the starter motor; and
starting time ignition control means for causing ignition in a cylinder of the engine to be ignited during a crank angle position of the engine being in a section suitable for performing ignition at the time of start-up in the cylinder, while the starter forward rotational drive means drives the starter motor in the forward rotational direction,
wherein the starter forward rotational drive means is comprised so as to continue driving the starter motor in the forward rotational direction until a start of the engine is verified even when the crankshaft stops before the piston in the cylinder of the engine reaches a top dead center of a compression stroke.

2. The engine starting device according to claim 1, wherein the starter motor is comprised so as to be able to drive the crankshaft in both of a forward rotational direction and a reverse rotational direction, and further comprises starter reverse rotational drive means for driving the starter motor in the reverse rotational direction in order to once reversely rotate the crankshaft when a start command for the engine is given; and
wherein the starter forward rotational drive means is comprised so as to drive the starter motor in the forward rotational direction in order to forwardly rotate the crankshaft after driving of the starter motor by the starter reverse rotational drive means is completed.

3. The engine starting device according to claim 2, wherein the starter reverse rotational drive means is comprised so as to drive the starter motor in the reverse rotational direction when the start command for the engine is given, and to reversely rotate the crankshaft of the engine until the piston in a specific cylinder, which has been stopped near a bottom dead center of a compression stroke at a time of forward rotation since the engine has stopped, is positioned in a section corresponding to an intake stroke at the time of forward rotation of the engine, or is in a position passed through the section.

4. The engine starting device according to claim 2, wherein the fuel injection control means is comprised so as to perform initial fuel injection when driving of the starter motor by the starter reverse rotational drive means is ended.

5. An engine starting device which starts an engine including at least one cylinder in which a piston is provided, a crankshaft connected to the piston in the cylinder, a fuel injection device which injects fuel in order to generate an air-fuel mixture supplied into the cylinder, an ignition device which ignites the air-fuel mixture compressed in the cylinder, and a starter motor which can rotationally drive the crankshaft in a forward rotational direction and a reverse rotational direction, comprising:
start reverse rotational drive mode switching means for switching a control mode to a start reverse rotational drive mode when a start command for the engine is given;
starter reverse rotational drive means for driving the starter motor in the reverse rotational direction in order to reverse the crankshaft when the control mode is switched to the start reverse rotational drive mode by the start reverse rotational drive mode switching means;
reverse rotational drive time determination means for determining whether an elapsed time after starting drive of the starter motor in the reverse rotational direction reaches a set time set at sufficient length of time when the piston in a specific cylinder, which has been stopped near a bottom dead center of a compression stroke at a time of forward rotation of the engine since the engine has stopped, arrives in a set position set within a section corresponding to an intake stroke at the time of forward rotation of the engine, or set in a position passed through the section;
reverse rotating time crank angle position determination means for determining whether the piston in the specific cylinder arrives in the set position while the starter motor is driven in the reverse rotational direction;
start forward rotational drive mode switching means for switching the control mode to a start forward rotational drive mode when the reverse rotational drive time determination means determines that the elapsed time reaches the set time, or when the reverse rotating time crank angle position determination means determines that the crank angle position arrives in the set position;
starter forward rotational drive means for starting drive of the starter motor in the forward rotational direction when the control mode is switched to the start forward rotational drive mode;
starting time ignition control means for causing ignition in a cylinder of the engine to be ignited during a crank angle position of the engine being in a section suitable for performing ignition at the time of start-up in the cylinder, while the starter forward rotational drive means drives the starter motor in the forward rotational direction;
fuel injection control means for causing the fuel injection device to perform initial fuel injection for said specific cylinder when the reverse rotational drive time determination means determines that the elapsed time reaches the set time, or when the reverse rotating time crank angle position determination means determines that the crank angle position arrives in the set position, and causing the fuel injection device to perform fuel injection in a crank angle position which is suitable as a position for injecting fuel for generating an air-fuel mixture supplied in a cylinder in which ignition is performed thereafter;
start completion determination means for determining whether a start of the engine is completed;
starter drive stopping means for stopping drive of the starter motor when the start completion determination means determines that the start of the engine is completed; and
normal operation mode switching means for switching the control mode to a normal operation mode when the start completion determination means determines that the start of the engine is completed,
wherein the starter forward rotational drive means is comprised so as to continue driving the starter motor in the forward rotational direction even when the crankshaft stops before the piston in the specific cylinder reaches a top dead center of a compression stroke.

6. The engine starting device according to claim 1, wherein the starting time ignition control means is comprised so as to make multiple ignition performed in a cylinder to be ignited, whenever it is detected that a crank angle position of the engine enters into the section suitable for performing ignition at the time of start-up in each cylinder of the engine.

7. The engine starting device according to claim 2, wherein the starting time ignition control means is comprised so as to make multiple ignition performed in a cylinder to be ignited, whenever it is detected that a crank angle position of the engine enters into the section suitable for performing ignition at the time of start-up in each cylinder of the engine.

8. The engine starting device according to claim 5, wherein the starting time ignition control means is comprised so as to make multiple ignition performed in a cylinder to be ignited, whenever it is detected that a crank angle position of the engine enters into the section suitable for performing ignition at the time of start-up in each cylinder of the engine.

9. The engine starting device according to claim 1, wherein the section suitable for performing ignition at the time of a start in each cylinder of the engine is a section in a fixed angular range which is behind a crank angle position corresponding to a top dead center position of a piston of each cylinder.

10. The engine starting device according to claim 2, wherein the section suitable for performing ignition at the time of a start in each cylinder of the engine is a section in a fixed angular range which is behind a crank angle position corresponding to a top dead center position of a piston of each cylinder.

11. The engine starting device according to claim 5, wherein the section suitable for performing ignition at the time of a start in each cylinder of the engine is a section in a fixed angular range which is behind a crank angle position corresponding to a top dead center position of a piston of each cylinder.

12. The engine starting device according to claim 1, wherein the starter motor comprises a magnet rotor, a stator having a multiphase armature coil, a Hall sensor for each phase which detects a pole of the magnet rotor in a detection position set to the armature coil for each phase of the stator, and outputs a rectangular wave detection signal, and is comprised so as to be driven as a brushless motor in starting the engine; and
wherein the starting time ignition control means and the fuel injection control means are comprised so as to acquire crank angle information on the engine necessary for control from an output of the Hall sensor for each phase.

13. The engine starting device according to claim 2, wherein the starter motor comprises a magnet rotor, a stator having a multiphase armature coil, a Hall sensor for each phase which detects a pole of the magnet rotor in a detection position set to the armature coil for each phase of the stator, and outputs a rectangular wave detection signal, and is comprised so as to be driven as a brushless motor in starting the engine; and
wherein the starting time ignition control means and the fuel injection control means are comprised so as to acquire crank angle information on the engine necessary for control from an output of the Hall sensor for each phase.

14. The engine starting device according to claim 5, wherein the starter motor comprises a magnet rotor, a stator having a multiphase armature coil, a Hall sensor for each phase which detects a pole of the magnet rotor in a detection position set to the armature coil for each phase of the stator, and outputs a rectangular wave detection signal, and is comprised so as to be driven as a brushless motor in starting the engine; and
wherein the starting time ignition control means and the fuel injection control means are comprised so as to acquire crank angle information on the engine necessary for control from output of the Hall sensors for each phase.

15. The engine starting device according to claim 1, wherein the engine comprises a decompression hole, which makes the interior of each cylinder communicate the outside, in a cylinder head.

16. The engine starting device according to claim 2, wherein the engine comprises a decompression hole, which makes the interior of each cylinder communicate the outside, in a cylinder head.

17. The engine starting device according to claim 5, wherein the engine comprises a decompression hole, which makes the interior of each cylinder communicate the outside, in a cylinder head.

18. The engine starting device according to claim 15, wherein a decompression valve which opens and closes the decompression hole and is controllable is provided, and decompression valve control means is further provided, the decompression valve control means controlling the decompression valve so as to open the decompression valve in starting the engine, and to close the decompression valve after the start of the engine.

19. The engine starting device according to claim 16, wherein a decompression valve which opens and closes the decompression hole and is controllable is provided, and decompression valve control means is further provided, the decompression valve control means controlling the decompression valve so as to open the decompression valve in starting the engine, and to close the decompression valve after the start of the engine.

20. The engine starting device according to claim 17, wherein a decompression valve which opens and closes the decompression hole and is controllable is provided, and decompression valve control means is further provided, the decompression valve control means controlling the decompression valve so as to open the decompression valve in starting the engine, and to close the decompression valve after the start of the engine.
